(19) United States
(12) Patent Application Publication
(10) Pub. No.: US 2022/0388321 A1
(43) Pub. Date: Dec. 8, 2022

(54) PRINTING APPARATUS AND CONTROL METHOD THEREOF

(71) Applicant: CANON KABUSHIKI KAISHA, Tokyo (JP)

(72) Inventors: Rie Takekoshi, Kanagawa (JP); Hiroto Kango, Tokyo (JP); Kazuhiko Sato, Tokyo (JP); Kazuo Suzuki, Kanagawa (JP); Toshimitsu Danzuka, Tokyo (JP); Masataka Kato, Kanagawa (JP); Shin Genta, Kanagawa (JP); Kazuki Narumi, Tokyo (JP); Tomoki Yamamuro, Kanagawa (JP); Takaaki Shima, Kanagawa (JP); Keita Ishimi, Kanagawa (JP)

(21) Appl. No.: 17/829,651

(22) Filed: Jun. 1, 2022

(30) Foreign Application Priority Data
Jun. 4, 2021 (JP) 2021-094575

(51) Int. Cl. B41J 25/00; B41J 2/165; B41J 29/393

(52) U.S. Cl. CPC B41J 25/001; B41J 2/16535; B41J 29/393

(57) ABSTRACT

A printing apparatus comprises a carriage including a print head that discharges ink, the carriage reciprocally moving relative to a print medium, a wiping unit configured to wipe a discharge port surface, and a control unit configured to control a movement operation of the carriage and a wiping operation of the wiping unit such that when a deceleration when stopping the carriage is a first deceleration, a time from when the carriage stops to when the wiping unit starts wiping is set to a first time, and when the deceleration when stopping the carriage is a second deceleration lower than the first deceleration, the time from when the carriage stops to when the wiping unit starts wiping is set to a second time shorter than the first time.

### BACKGROUND OF THE INVENTION

### Field of the Invention

The present invention relates to an ink jet printing apparatus equipped with means for wiping a discharge port surface.

### Description of the Related Art

In conventional ink jet printing apparatuses, in which an ink jet print head mounted on a carriage is moved reciprocally for printing, a larger capacity ink tank is necessary to reduce the frequency with which the ink tank is replaced. However, in systems where the ink jet print head and ink tank are integrated, mounting a large ink tank on the carriage increases the inertia of the carriage. Accordingly, ink jet printing apparatuses having ink tanks installed in non-moving positions, rather than on moving objects such as carriages, are known. The ink tank is connected to the print head on the carriage by a supply tube, and ink is supplied from the ink tank to the print head.

In the above-described configuration, it is known that when the ink in the supply tube oscillates as the carriage moves, dynamic pressure is applied to the ink due to inertia. Japanese Patent Laid-Open No. 2013-226738 discloses a configuration which fills a sub-tank with ink by controlling the acceleration of a carriage using dynamic pressure of the ink produced in the tube. “Sub-tank” refers to an ink holding unit provided between a main tank and the print head.

On the other hand, in ink jet printing apparatuses, fine droplets produced by ink ejection, splash-back of ejected ink from the print medium, and the like may adhere to the discharge port surface. Such adhering objects can cause blockage of the discharge port, come into contact with the ejected ink droplets, or the like, reducing the quality of the printed image. In order to suppress such printing defects, a technique is known in which the discharge port surface is wiped with a blade or the like to remove adhering ink droplets and the like. Japanese Patent Laid-Open No. 2000-094701 discloses an ink jet printing apparatus that wipes the discharge port surface of the print head during and after printing (after the print paper is discharged).

When ink flows from the supply tube into the print head due to dynamic pressure applied to the ink within the supply tube, the internal pressure in the print head rises. Japanese Patent Laid-Open No. 2013-226738 states that this dynamic pressure of ink is proportional to the acceleration/deceleration of the carriage, and the same is true for the internal pressure in the print head. In other words, depending on the magnitude of the acceleration/deceleration, the internal pressure in the print head may become a positive pressure after the carriage stops. In Japanese Patent Laid-Open No. 2000-094701, wiping is performed after the carriage stops. In this case, a convex meniscus formed at the discharge port may be broken by the wiping member, and subsequent movement of the carriage may cause ink to drip from the discharge port onto the print medium or the like, reducing the quality of the printed image.

Note that ink leakage can be suppressed by reducing the internal pressure in the print head from a positive pressure to a negative pressure during an operating time, such as raising and lowering the wiper after the carriage stops and before the wiping operations are executed.

On the other hand, if the carriage is moved at a higher speed to improve throughput, the acceleration/deceleration of the carriage must also be increased, and the range over which the internal pressure in the print head rises and falls increases accordingly.

Particularly when printing operations are performed at high speed, it may not be possible to secure time for the internal pressure in the print head to drop from a positive pressure to a negative pressure before the wiping operations are executed.

### SUMMARY OF THE INVENTION

Having been achieved in light of the above-described issue, the present invention suppresses a drop in image quality caused by ink leakage from a discharge port after wiping.

According to a first aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when a deceleration when stopping the carriage is a first deceleration, a time from when the carriage stops to when the wiping unit starts wiping the discharge port surface is set to a first time, and when the deceleration when stopping the carriage is a second deceleration lower than the first deceleration, the time from when the carriage stops to when the wiping unit starts wiping the discharge port surface is set to a second time shorter than the first time.

According to a second aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when a movement distance at a constant speed of the carriage before stopping the carriage is a first distance, a time from when the carriage stops to when the wiping unit starts wiping the discharge port surface is set to a first time, and when the movement distance at the constant speed of the carriage is a second distance longer than the first distance, the time from when the carriage stops to when the wiping unit starts wiping the discharge port surface is set to a second time shorter than the first time.

According to a third aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the carriage stops to when the wiping unit starts wiping the discharge port surface is set to a first time, and when the printing strike density is a second strike density higher than the first strike density, the time from when the carriage stops to when the wiping unit starts wiping the discharge port surface is set to a second time shorter than the first time.

According to a fourth aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when the carriage is stopped without wiping the discharge port surface, a deceleration of the carriage is set to a first deceleration, and when the carriage is stopped in order to wipe the discharge port surface, the deceleration of the carriage is set to a second deceleration lower than the first deceleration.

According to a fifth aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when a deceleration when stopping the carriage is a first deceleration, a time from when the wiping unit finishes wiping the discharge port surface to when a next movement operation of the carriage starts is set to a first time, and when the deceleration when stopping the carriage is a second deceleration lower than the first deceleration, the time from when the wiping unit finishes wiping the discharge port surface to when the next movement operation of the carriage starts is set to a second time shorter than the first time.

According to a sixth aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when a movement distance at a constant speed of the carriage before stopping the carriage is a first distance, a time from when the wiping unit finishes wiping the discharge port surface to when a next movement operation of the carriage starts is set to a first time, and when the movement distance at the constant speed of the carriage is a second distance longer than the first distance, the time from when the wiping unit finishes wiping the discharge port surface to when the next movement operation of the carriage starts is set to a second time shorter than the first time.

According to a seventh aspect of the present invention, there is provided a printing apparatus comprising: a carriage including a print head that discharges ink, the carriage reciprocally moving relative to a print medium; a wiping unit configured to wipe a discharge port surface in which an ink discharge port of the print head is formed; and a control unit configured to control a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the wiping unit finishes wiping the discharge port surface to when a next movement operation of the carriage starts next is set to a first time, and when the printing strike density is a second strike density higher than the first strike density, the time from when the wiping unit finishes wiping the discharge port surface to when the next movement operation of the carriage starts is set to a second time shorter than the first time.

According to an eighth aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when a deceleration when stopping the carriage is a first deceleration, a time from when the carriage stops to when the wiping unit starts wiping the discharge port surface is set to a first time, and when the deceleration when stopping the carriage is a second deceleration lower than the first deceleration, the time from when the carriage stops to when the wiping unit starts wiping the discharge port surface is set to a second time shorter than the first time.

According to a ninth aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when a movement distance at a constant speed of the carriage before stopping the carriage is a first distance, a time from when the carriage stops to when the wiping unit starts wiping the discharge port surface is set to a first time, and when the movement distance at the constant speed of the carriage is a second distance longer than the first distance, the time from when the carriage stops to when the wiping unit starts wiping the discharge port surface is set to a second time shorter than the first time.

According to a 10th aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the carriage stops to when the wiping unit starts wiping the discharge port surface is set to a first time, and when the printing strike density is a second strike density higher than the first strike density, the time from when the carriage stops to when the wiping unit starts wiping the discharge port surface is set to a second time shorter than the first time.

According to an 11th aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when the carriage is stopped without wiping the discharge port surface, a deceleration of the carriage is set to a first deceleration, and when the carriage is stopped in order to wipe the discharge port surface, the deceleration of the carriage is set to a second deceleration lower than the first deceleration.

According to a 12th aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when a deceleration when stopping the carriage is a first deceleration, a time from when the wiping unit finishes wiping the discharge port surface to when a next movement operation of the carriage starts is set to a first time, and when the deceleration when stopping the carriage is a second deceleration lower than the first deceleration, the time from when the wiping unit finishes wiping the discharge port surface to when the next movement operation of the carriage starts is set to a second time shorter than the first time.

According to a 13th aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when a movement distance at a constant speed of the carriage before stopping the carriage is a first distance, a time from when the wiping unit finishes wiping the discharge port surface to when a next movement operation of the carriage starts is set to a first time, and when the movement distance at the constant speed of the carriage is a second distance longer than the first distance, the time from when the wiping unit finishes wiping the discharge port surface to when the next movement operation of the carriage starts is set to a second time shorter than the first time.

According to a 14th aspect of the present invention, there is provided a method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising: controlling a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the wiping unit finishes wiping the discharge port surface to when a next movement operation of the carriage starts next is set to a first time, and when the printing strike density is a second strike density higher than the first strike density, the time from when the wiping unit finishes wiping the discharge port surface to when the next movement operation of the carriage starts is set to a second time shorter than the first time.

Further features of the present invention will become apparent from the following description of exemplary embodiments with reference to the attached drawings.

### BRIEF DESCRIPTION OF THE DRAWINGS

FIG. 1 is a diagram illustrating the overall configuration of an ink jet printing apparatus according to a first embodiment.

FIG. 2 is a schematic diagram of a print head according to the first embodiment.

FIG. 3A is a schematic diagram of a recovery unit according to the first embodiment.

FIG. 3B is a schematic diagram of the recovery unit according to the first embodiment.

FIG. 3C is a schematic diagram of the recovery unit according to the first embodiment.

FIG. 3D is a schematic diagram of the recovery unit according to the first embodiment.

FIG. 3E is a schematic diagram of the recovery unit according to the first embodiment.

FIG. 4 is a schematic cross-sectional view of an ink channel for one color in the ink jet printing apparatus according to the first embodiment.

FIG. 5 is a block diagram illustrating a control configuration according to the first embodiment.

FIGS. 6A and 6B are diagrams illustrating a speed profile of a carriage and an internal pressure profile of the print head.

FIG. 7A is a schematic diagram of the print head and a supply tube during carriage scanning.

FIG. 7B is a schematic diagram of the print head and the supply tube during carriage scanning.

FIG. 7C is a schematic diagram of the print head and the supply tube during carriage scanning.

FIG. 8A is a diagram illustrating a speed profile after the carriage starts decelerating.

FIG. 8B is a diagram illustrating an internal pressure profile of the carriage after the carriage starts decelerating.

FIG. 8C is a diagram illustrating a speed profile after the carriage starts decelerating.

FIG. 8D is a diagram illustrating an internal pressure profile of the carriage after the carriage starts decelerating.

FIG. 8E is a cross-sectional view of the vicinity of a discharge port of the print head.

FIG. 8F is a cross-sectional view of the vicinity of the discharge port of the print head.

FIG. 8G is a cross-sectional view of the vicinity of the discharge port of the print head.

FIG. 8H is a cross-sectional view of the vicinity of the discharge port of the print head.

FIG. 9A is a flowchart illustrating wiping operations according to the first embodiment.

FIG. 9B is a diagram illustrating a wait time according to the first embodiment.

FIGS. 10A and 10B are diagrams illustrating a speed profile of the carriage and an internal pressure profile of the print head according to a second embodiment.

FIG. 11 is a schematic diagram illustrating scanning during printing as a vector.

FIGS. 12A and 12B are diagrams illustrating a speed profile of the carriage and an internal pressure profile of the print head according to the second embodiment.

FIG. 13A is a flowchart illustrating wiping operations according to the second embodiment.

FIG. 13B is a diagram illustrating carriage deceleration immediately before wiping according to the second embodiment.

FIG. 14A is a diagram illustrating a speed profile after the carriage starts decelerating.

FIG. 14B is a diagram illustrating an internal pressure profile of the carriage after the carriage starts decelerating.

FIG. 14C is a diagram illustrating a speed profile after the carriage starts decelerating.

FIG. 14D is a diagram illustrating an internal pressure profile of the carriage after the carriage starts decelerating.

FIG. 15A is a flowchart illustrating wiping operations according to a third embodiment.

FIG. 15B is a diagram illustrating a wait time according to the third embodiment.

FIG. 16A is a diagram illustrating a speed profile after the carriage starts decelerating.

FIG. 16B is a diagram illustrating an internal pressure profile of the carriage after the carriage starts decelerating.

FIG. 16C is a diagram illustrating a speed profile after the carriage starts decelerating.

FIG. 16D is a diagram illustrating an internal pressure profile of the carriage after the carriage starts decelerating.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In this specification, “print” refers not only to forming meaningful information such as text, diagrams, and the like, but also to information which is not meaningful. “Printing” refers broadly to forming an image, a design, a pattern, or the like on a print medium or the processing of a medium, regardless of whether or not the image or the like is manifested in a way that can be perceived visually by humans. “Print medium” refers not only to paper used in general printing apparatuses, but also to a wide range of media that can accept ink, including cloth, plastic film, metal plates, glass, ceramics, wood, leather, and the like. Furthermore, “ink” (sometimes referred to as “liquid”) should be interpreted as broadly as the definition of “print” above. Accordingly, “ink” represents a liquid that can be supplied to a print medium to form an image, a design, a pattern, or the like, the processing of the print medium, or processing of the ink (e.g., solidifying or insolubilizing the coloring material in the ink applied to the print medium). Furthermore, unless otherwise specified, “nozzle” refers collectively to a discharge port, a liquid channel connected thereto, and an element that generates the energy used for ink discharge.

### First Embodiment

Hereinafter, an ink jet printing apparatus according to a first embodiment of the present invention will be described in detail with reference to the appended drawings.

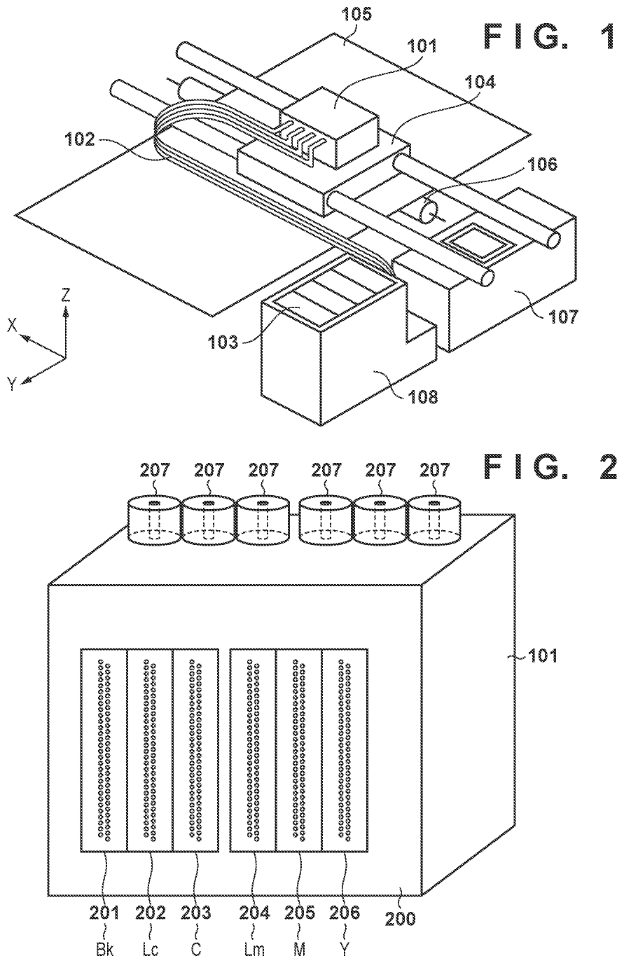

FIG. 1 is a schematic perspective view of the main printing elements of a serial scanning-type printing apparatus according to the present embodiment. In FIG. 1, a carriage 104 holds a print head 101 and moves for main scanning relative to a print medium 105 in the direction indicated by the coordinate axis X (a main scanning direction). The carriage 104 is driven by a carriage motor (not shown) attached to the body of the ink jet printing apparatus pulling a drive belt (not shown) fixed to the carriage 104. A transport roller 106 transports the print medium 105 in the direction indicated by the coordinate axis Y (a sub scanning direction) as the roller rotates. An image is formed on the print medium in stages by alternately repeating the main scan, in which the carriage 104 moves in the main scanning direction while the print head 101 discharges ink according to printing data, and the transport operation of transporting the printing medium by rotating the transport roller 106. When ink in the print head 101 is consumed during the printing operations, ink is supplied from an ink supply system 108 through a supply tube 102. A plurality of ink tanks 103, each holding a different color of ink, are installed in the ink supply system 108.

A recovery unit 107 is installed outside a printing region in the movement direction of the carriage 104. The carriage 104 stops at a home position outside the printing region before the start of the printing operations, as needed during the printing operations, and the like. “Home position” means the rightmost position in the diagram with respect to the main scanning direction of the carriage. The leftmost position in the diagram with respect to the main scanning direction of the carriage will be called a “back position”. The recovery unit 107 is provided in a position opposite the print head 101 when the carriage 104 stops at the home position. The recovery unit 107 performs cleaning operations by sucking ink and air from a plurality of discharge ports provided on a discharge port surface 200 of the print head 101, wiping operations for removing ink, foreign objects, and the like adhering to the discharge port surface, and the like as necessary.

FIG. 2 is a schematic diagram of the print head according to the present embodiment. FIG. 2 is a diagram illustrating the print head 101 viewed from the direction in which ink is discharged (downward). The print head 101 has the discharge port surface (nozzle surface) 200 provided with a plurality of discharge port rows (nozzle rows) 201 to 206, in each of which a plurality of discharge ports (nozzles) for discharging ink are arranged. The discharge port rows 201 to 206 are disposed side by side along the movement direction of the carriage 104 so as to be capable of discharging different shades (including color and density) of ink. For example, the discharge port rows 201 to 206 capable of ejecting black (Bk), light cyan (Lc), cyan (C), light magenta (Lm), magenta (M), and yellow (Y) inks are disposed side by side along the movement direction of the carriage 104. Ink is supplied to each discharge port from an ink inlet part 207, which is connected to an ink tank (not shown) by a tube, through an ink channel inside the print head. The print head 101 according to the present embodiment is an ink jet-type print head that uses thermal energy to discharge ink, and includes a plurality of electro-thermal converters for generating thermal energy. In other words, the print head 101 generates thermal energy using pulse signals applied to the electro-thermal converters. The thermal energy causes film boiling of ink in ink foaming chambers (not shown), and the ink is discharged from the discharge ports using foaming pressure from the film boiling. The ink discharge method is not limited thereto, and may employ piezoelectric elements as well.

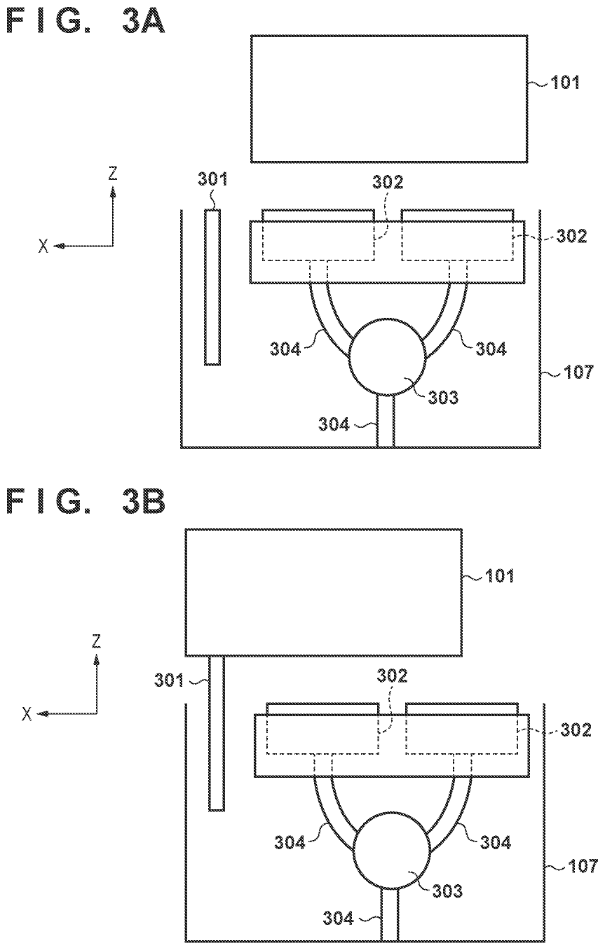

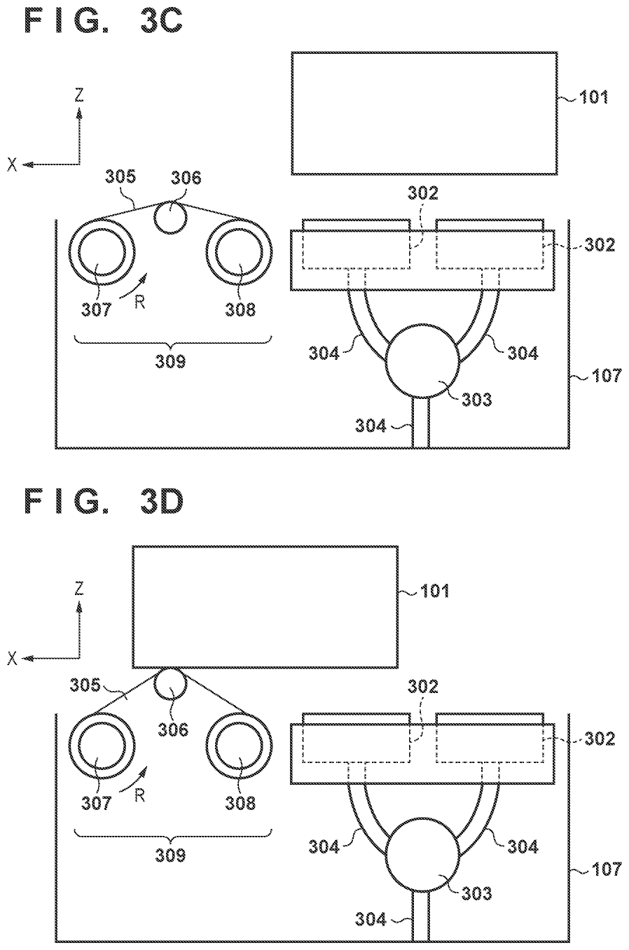

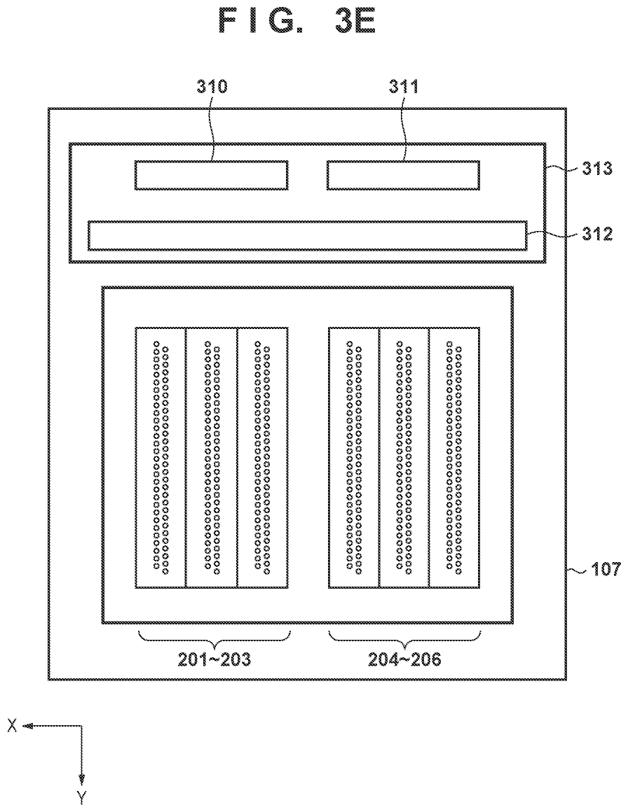

FIGS. 3A and 3B are schematic diagrams illustrating the recovery unit 107 according to the present embodiment. The recovery unit 107 is configured including a cap 302 that covers the discharge port surface of the print head 101, a suction pump 303 that sucks ink from the print head when the cap 302 covers the discharge port surface, and a wiper 301 that wipes the discharge port surface of the print head. The cap 302 is supported by a raising/lowering mechanism (not shown) capable of raising and lowering, and moves between a raised position and a lowered position. In the raised position, the cap 302 contacts the print head 101 and covers (caps) the discharge port surface 200 of the print head 101. By covering the discharge port surface 200, the cap 302 can prevent the discharge ports of the print head 101 from drying and ink from evaporating outside of printing operations, or can suction ink from the print head 101 by driving the suction pump 303 (described later).

The cap 302 is positioned in the lowered position during printing operations to avoid interference with the print head 101, which moves with the carriage 104. With the cap 302 in the lowered position, the print head 101 can pre-discharge against the cap 302 upon moving to a position opposite the cap 302. The wiper 301 contacts and retracts from the discharge port surface 200 by reciprocally moving between a wiping position and a retracted position in the direction of the arrow Z, using a well-known means, in order to remove foreign objects such as ink residues that adhere to the discharge port surface 200. In other words, the wiper 301 is in the retracted position, as illustrated in FIG. 3A, when not wiping. On the other hand, during wiping operations, as illustrated in FIG. 3B, the wiper 301 moves to the wiping position, and in that state, the carriage 104 moves in the direction of the arrow X, and the wiper 301 wipes the discharge port surface 200 to perform the wiping operations.

The suction pump 303 is driven when the cap 302 covers the discharge port surface 200 of the print head 101 and the interior thereof is a substantially airtight space, and performs suction operations to suck ink from the print head 101 by generating negative pressure within the airtight space. The suction operations are performed when the print head 101 is filled with ink from the ink tank 103 (during initial filling), when dust, adhering matter, air bubbles, and the like in the discharge ports are suctioned and removed (during suction recovery), and the like. The cap 302 is connected to a waste ink absorber (not shown) by a flexible tube 304.

In the present embodiment, the wiper 301 is constituted by an elastic material such as rubber, but the wiper 301 may also be a member constituted by a sheet of porous material that absorbs ink. Compared to elastic materials, porous materials are more likely to absorb and draw ink from the discharge ports during wiping, which enhances the effect of the present embodiment. FIGS. 3C and 3D are schematic diagrams of the recovery unit 107 provided with a wiping unit 309 constituted by a sheet-shaped porous material.

The wiping unit 309 includes a liquid-impregnated member (wiping member) 305, which is constituted by a porous material formed in the shape of an elongated sheet and is pre-impregnated with a wiping liquid having a low-volatility solvent, such as polyethylene glycol or the like, as a main component. This liquid-impregnated member (wiping member) 305 will also be referred to as a “sheet member” hereinafter.

The sheet member 305, formed in the shape of an elongated sheet, is wound into a roll shape around a first core member 307 at one end and a second core member 308 at the other end. The sheet member 305 is disposed such that the part that is not wound into a roll shape (called a “non-rolled part” hereinafter) faces the ink discharge port surface 200 while the print head 101 reciprocally moves. In other words, the non-rolled part of the sheet member 305 is positioned higher in the vertical direction than the first core member 307 and the second core member 308.

The sheet member 305 is supported by a support member 306, constituted by an elastic material, on the back surface of the non-rolled part (the surface on the opposite side from the surface facing the ink discharge port surface 200). The support member 306 contacts and retracts from the discharge port surface 200 by reciprocally moving between a wiping position and a retracted position in the direction of the arrow Z, using a well-known means, in order to remove foreign objects such as ink residues that adhere to the discharge port surface 200. In other words, the support member 306 is in the retracted position, as illustrated in FIG. 3C, when not wiping. On the other hand, during wiping operations, as illustrated in FIG. 3D, the support member 306 moves to the wiping position, and in that state, the carriage 104 moves in the direction of the arrow X to perform the wiping operations.

The first core member 307 is driven by a transport motor of the sheet member 305, and is configured to rotate in a direction R indicated in FIGS. 3C and 3D. This makes it possible to transport the sheet member 305 in the same direction as the outbound direction of the carriage 104 (see the arrow X direction). On the other hand, the second core member 308 rotates in response to the rotation of the first core member 307, but the first core member 307 is provided with a well-known torque limiter to prevent rotation when the support member 306 reciprocally moves in the vertical direction. A transport length (transport amount) of the sheet member 305 is controlled by the rotation amount of the transport motor, but may also be configured to be controlled based on a measurement result from a well-known means, e.g., a transport length measuring means using an optical means. At this time, it is preferable that a scale for length measurement be attached to an edge of the sheet member 305 following the transport direction thereof.

In the present embodiment, the wiping direction is the direction in which the discharge port rows are arranged in the print head, but the configuration may be such that the movement is in a direction that intersects (is orthogonal to) the stated direction (the direction in which the discharge ports are arranged). FIG. 3E is a schematic diagram illustrating the recovery unit having a configuration in which the wiper moves in the direction in which the discharge ports are arranged. FIG. 3E is a diagram seen from the +Z direction in FIG. 1.

In the present embodiment, two wipers 310 and 311 are provided for wiping three discharge port rows (201 to 203 and 204 to 206), respectively, in FIG. 2, and a wiper 312 is provided for wiping the entire discharge port surface including the discharge port rows 201 to 206. The wipers 310 and 311 are fixed to a wiper holder 313. The wiper holder 313 can move in a front-back direction (in the direction in which the discharge ports are arranged in the print head 101), indicated as the Y direction in the drawing. When the print head 101 is positioned in the home position, wiping operations, in which the wipers 310 and 311 contact the discharge port surface while wiping the discharge port surface, can be performed by the wiper holder 313 moving in the +Y direction (one direction). When the wiping operations end, the carriage 104 is moved and retracted from the region where the wiping operations are performed, and then the wiper holder 313 is moved and returned to its original position (the position before the wiping operations).

In the configuration illustrated in FIG. 3E, too, the wiper is not limited to an elastic member such as rubber, and may be a member constituted by a porous material that absorbs ink.

In the present embodiment, the configuration is such that the wiping is performed only when the wiper moves in one direction, but the configuration may be such that the wiping is performed when the wiper moves in both the forward and backward directions.

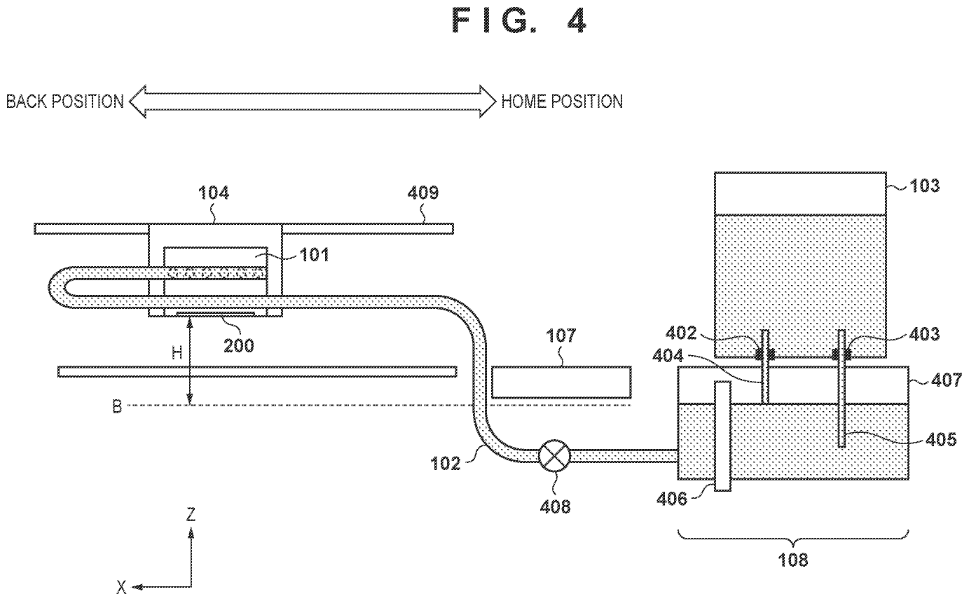

FIG. 4 is a diagram illustrating the main printing elements in FIG. 1, seen from the +Y direction. FIG. 4 illustrates a serial scanning-type ink jet printing apparatus in which the ink tank 103 is disposed in a fixed position in the ink jet printing apparatus body and ink is supplied to the print head 101 on the carriage 104 through the tube 102. The path of ink from the ink tank 103 to the print head 101 is also illustrated. The supply tube 102 is disposed so as to have a section substantially parallel to the movement direction of the carriage 104. Note that the arrangement of the supply tube 102 illustrated in FIG. 4 is only an example and is not limited thereto.

The ink supply system 108 is held and fixed in a predetermined position in the body of the printing apparatus. In the present embodiment, a sub-tank 407 is provided vertically below the ink tank 103, and the sub-tank 407 includes a first hollow pipe 404 and a second hollow pipe 405 that extend vertically upward. The sub-tank 407 is also provided with an atmospheric communication port 406. The ink tank 103 has, in its bottom, a first joint part 402 and a second joint part 403. By inserting the first hollow pipe 404 into the first joint part 402 and the second hollow pipe 405 into the second joint part 403, the ink tank 103 and the atmosphere communicate through the atmospheric communication port 406.

The print head 101 is connected by the supply tube 102 to the sub-tank 407, which holds ink inside. During printing operations, ink is supplied from the sub-tank 407 through the supply tube 102 as needed as ink in the print head 101 is consumed by the ink being discharged from each discharge port. When ink in the sub-tank 407 is consumed, the liquid level in the sub-tank 407 first drops. Then, the ink level in the sub-tank 407 is separated from the bottom end of the first hollow pipe 404, and the ink tank 103 communicates with the atmosphere through the first hollow pipe 404. By communicating with the atmosphere, air is discharged from the atmospheric communication port 406 and the ink level in the ink tank 103 drops, causing the sub-tank 407 to be filled with ink again. When the liquid level rises to the same position as a vertical position indicated by B in FIG. 4, the bottom end of the first hollow pipe 404 is again blocked with ink, and ink transfer from the ink tank 103 to the sub-tank 407 stops, i.e., the filling is completed.

In addition, the vertical position and the like of the sub-tank 407 are set such that the ink level in the sub-tank 407 is below the discharge port surface 200 of the print head 101 in the direction of gravity. Accordingly, the pressure in the print head 101 is maintained at a negative pressure due to what is known as the “water head difference”. The vertical position and the like of the sub-tank 407 are set such that a meniscus formed at the ink discharge port is not broken by this negative pressure. Note that in the present embodiment, a height difference between the discharge port surface 200 and the ink level in the sub-tank 407, i.e., a water head difference H, is about 80 mm. An on/off valve 408 is provided in the supply tube 102 adjacent to the sub-tank 407, and opens and closes the ink channel constituted by the supply tube 102. When the ink jet printing apparatus is transported, the on/off valve 408 is closed to prevent ink from leaking and dripping from the discharge port. The foregoing has been an overview of the ink supply system using the water head difference method according to the present embodiment.

A pressurized method using a regulator and the like can be given as other ink supply methods, and the effects of the present embodiment can be achieved regardless of the supply method. In particular, in the water head difference method, the internal pressure in the print head is controlled only by the water head difference, and because the pressure fluctuation effect exerted by the ink dynamic pressure caused by carriage movement is large, the effects of the present embodiment are even more pronounced.

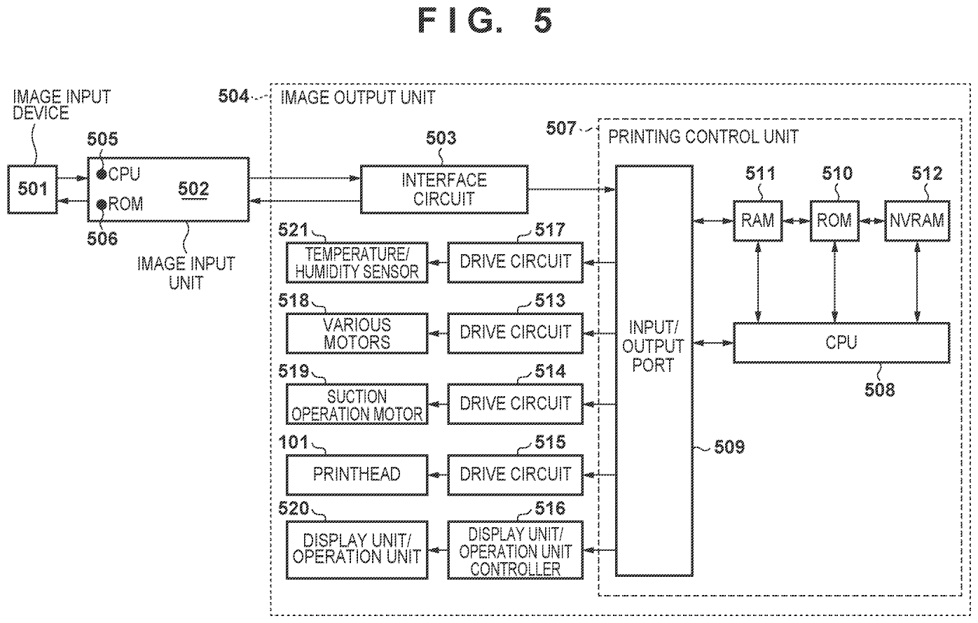

A control configuration for executing printing control of the ink jet printing apparatus will be described next. FIG. 5 is a block diagram illustrating the configuration of a control system of the ink jet printing apparatus illustrated in FIG. 1.

In FIG. 5, first, multi-value image data stored in an image input device 501, such as a scanner or a digital camera, and various storage media, such as a hard disk, and the like, is input to an image input unit 502. The image input unit 502 is a host computer connected to the exterior of the printing apparatus, and transfers image information to be printed to an image output unit 504, which is the printing apparatus, via an interface circuit 503. The image input unit 502 is provided with a CPU 505, which is necessary for transferring image data, and a storage device (ROM 506). The host computer can be in the form of a computer serving as an information processing device, in the form of an image reader, or the like.

A CPU 508, an input/output port 509, a storage device (ROM 510) that stores control programs and the like, RAM 511 that serves as a work area when performing various type of image processing, and non-volatile memory NVRAM 512 are provided in a printing control unit 507. The ROM 510 stores various types of data such as control programs for the CPU 508 and parameters necessary for printing operations. The RAM 511 is used as a work area for the CPU 508, and also temporarily stores various types of data such as image data received from the image input unit 502 and generated printing data. An image is formed by applying ink to the print medium from each discharge port of the print head 101 based on the image data converted in the printing control unit 507.

In addition, various types of motors 518 for operating the carriage and an LF (line feed), a suction operation motor 519, the print head 101, and corresponding drive circuits 513, 514, and 515, are connected to the printing control unit 507 through the input/output port 509. The suction operation motor 519 is a drive source for operating the suction pump 303 in order to suction and discharge ink from the print head 101 described with reference to FIG. 2. Furthermore, sensors such as a temperature/humidity sensor 521, which detects the temperature and humidity of the surrounding environment, and a drive circuit 517 thereof, are connected to the input/output port 509. Furthermore, a display unit/operation unit controller 516 is also connected to control a display unit, an operation unit 520, and the like of the ink jet printing apparatus.

Internal pressure fluctuations in the print head 101 due to the movement of the carriage 104 will be described next.

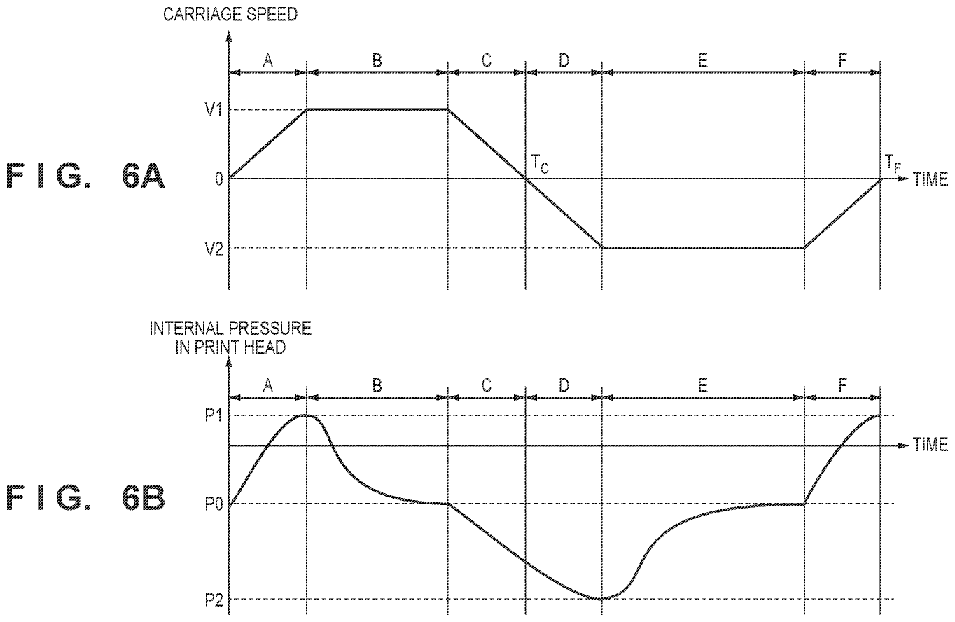

FIG. 6A illustrates an example of a carriage speed profile when the carriage 104 makes one reciprocal scan from the home position side and wiping is executed. FIG. 6B illustrates an example of an internal pressure profile of the print head at that time. In FIG. 6A, the horizontal axis represents time and the vertical axis represents the carriage speed. The speed at which the carriage moves in the positive direction of the X axis in FIG. 1 is assumed to be positive. In FIG. 6B, the horizontal axis represents time and the vertical axis represents the internal pressure in the print head.

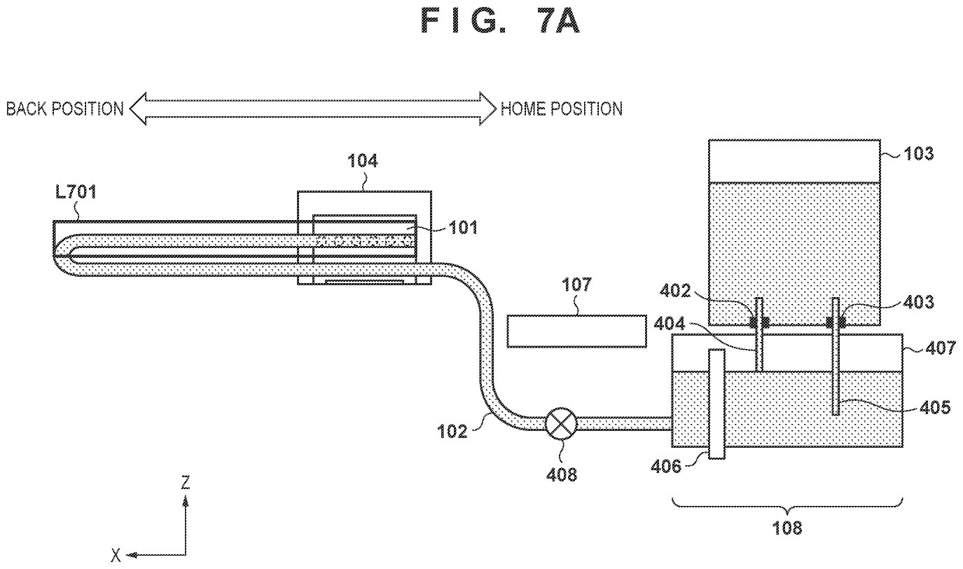

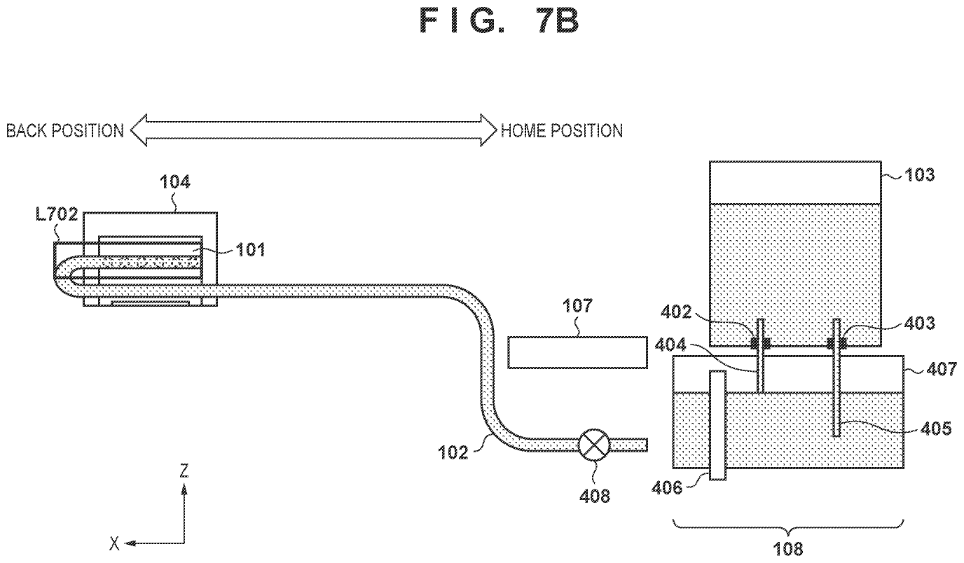

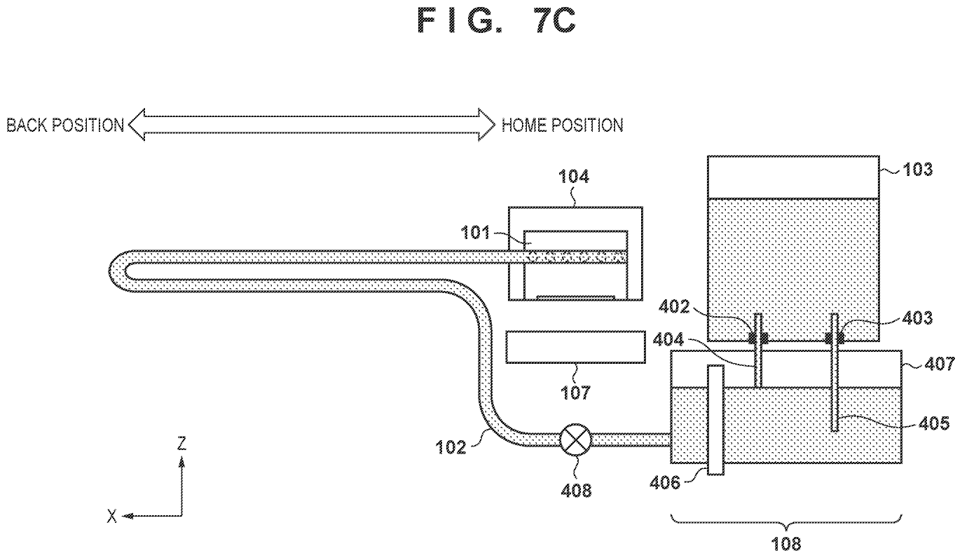

FIG. 7A is a schematic diagram illustrating the arrangement of the supply tube 102 at time 0 in FIG. 6A. This is the moment when the carriage 104 starts scanning from the home position side, and the speed is 0.

In period A in FIG. 6A, the carriage 104 starts moving from the home position side and accelerates until reaching a predetermined speed V1. In the present embodiment, acceleration is performed until a speed of 60 inches/sec is reached. When the carriage 104 accelerates on the home position side as illustrated in FIG. 7A, ink dynamic pressure due to inertia is generated in the direction from the sub-tank 407 toward the print head 101. The generated ink dynamic pressure causes the ink in the tube to move in the direction of the print head 101, thus increasing the pressure in the print head 101. In period A in FIG. 6B, the internal pressure in the print head 101 rises to P1. In the present embodiment, the internal pressure increases to +10 mmaq.

Next, in period B, the carriage 104 moves at a constant speed V1. At this time, no inertia acts on the ink, and thus the internal pressure in the print head 101 gradually decreases toward a reference pressure P0. Here, “reference pressure P0” is the internal pressure in the print head 101 when the carriage 104 is stationary, which in the present embodiment is −80 mmaq. Because the internal pressure in the print head 101 has increased in period A, the internal pressure in the print head 101 decreases toward the reference pressure P0 in period B in FIG. 6B.

Next, in periods C and D, the carriage 104 decelerates on the back position side, reverses direction, and then accelerates, moving in the opposite direction at a speed V2. In the present embodiment, the speed V2 is also set to 60 inches/sec. FIG. 7B is a schematic diagram illustrating the arrangement of the supply tube 102 at time TC in FIG. 6A. When the carriage 104 decelerates on the left end side of the main scanning direction and then accelerates in the opposite direction, ink dynamic pressure due to inertia is generated in the ink in the tube in the direction from the print head 101 toward the sub-tank 407. The generated ink dynamic pressure causes the ink in the tube to return in the direction of the sub-tank 407, thus reducing the pressure in the print head 101. During periods C and D in FIG. 6B, the internal pressure in the print head 101 drops to P2. In the present embodiment, the internal pressure drops to −85 mmaq.

Next, in period E, the carriage 104 moves at a constant speed, similar to period B. Because the internal pressure in the print head 101 is decreasing in period D, the internal pressure in the print head 101 increases toward the reference pressure P0 in period E in FIG. 6B. Next, it is necessary for the carriage 104 to stop on the recovery unit 107 to perform wiping after the carriage 104 stops. As such, the carriage scanning distance during period E is longer than the carriage scanning distance during period B. The time of period E is therefore longer than the time of period B.

Finally, in period F, deceleration is performed to stop the carriage 104 at a position above the recovery unit 107. The arrangement of the supply tube 102 at time TF (when the carriage stops) in FIG. 6A is illustrated in FIG. 7C. To perform wiping, the carriage 104 stops above the recovery unit 107. Because of the inertia in the same direction as in period A, the internal pressure in the print head 101 rises to P1 in period F in FIG. 6B. The foregoing has described pressure fluctuations caused by carriage movement. Hereinafter, acceleration when decelerating will be referred to as “deceleration”.

As described above, the internal pressure in the print head 101 is likely to be a positive pressure on the home position side where the recovery unit 107 is disposed. Accordingly, the effect of the present embodiment is greater if the supply tube 102 is connected from the back position side.

Here, the dynamic pressure of the ink in the tube can be expressed as follows:

Pn=(mn·an)/S . . . Formula (1)

mn: mass of ink subject to acceleration

S: cross-sectional area of supply tube

an: carriage acceleration

In this case, the ink mass at the time of maximum dynamic pressure can be expressed as follows:

mn=k·S·Ln . . . Formula (2)

k: relative density of ink

S: cross-sectional area of supply tube

Ln: maximum length of supply tube subject to inertia due to acceleration

By substituting Formula (2) into Formula (1), the following relationship is established:

Pn=k·Ln·an . . . Formula (3)

Here, “acceleration” is a difference between the carriage speed at the start of acceleration and the carriage speed at the end of acceleration, divided by an acceleration time. Similarly, “deceleration” is a difference between the carriage speed at the start of deceleration and the carriage speed at the end of deceleration, divided by a deceleration time. Both take the positive direction in the X axis in FIG. 1 as positive.

From Formula (3), it can be seen that the ink dynamic pressure is proportional to the acceleration/deceleration. The acceleration/deceleration is affected mainly by the carriage speed during printing. If the carriage speed is increased to improve throughput, the acceleration/deceleration will also increase, and conversely, if the carriage speed is reduced to improve image quality, the acceleration/deceleration will also decrease.

From Formula (3), it can also be seen that the ink dynamic pressure is proportional to the maximum length of the tube subjected to inertia due to acceleration. Accordingly, when the carriage 104 accelerates or decelerates on the home position side in an ink jet printing apparatus having a tube arrangement such as that illustrated in FIG. 4, the fluctuation range of the pressure generated in the print head 101 is greater than when the carriage 104 accelerates or decelerates on the back position side. This is because the maximum length of the supply tube subjected to inertia is longer (L701>L702) when the carriage 104 accelerates or decelerates on the home position end side, as in FIG. 7A, than when the carriage 104 accelerates or decelerates on the back position side, as in FIG. 7B.

Based on the foregoing, the range of the increase in the internal pressure in the print head due to carriage acceleration/deceleration on the home position side may be greater than the range of the decrease in the internal pressure in the print head due to carriage acceleration/deceleration on the back position side and the range of the increase in the internal pressure in the print head during movement at a constant speed. At this time, the internal pressure in the print head due to carriage acceleration/deceleration on the home position side remains at least the reference pressure P0.

Even in a system in which the print head and ink tank are integrated, this effect can be achieved if part of the ink channel has a section that is substantially parallel to the movement direction of the carriage. However, the effect of the present embodiment is greater in systems where ink is supplied from the ink tank to the print head by a supply tube.

Control for setting a wait time from the carriage stop to the start of the wiping operations, which is a characteristic part of the present embodiment, will be described next.

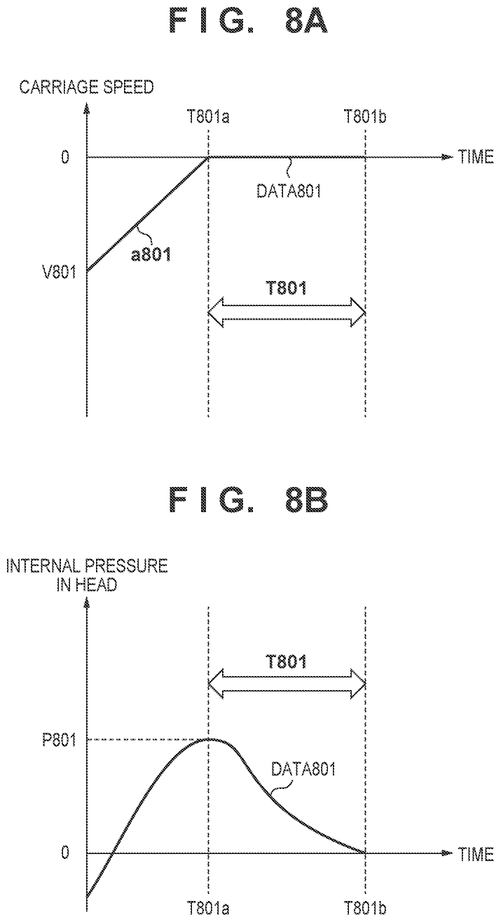

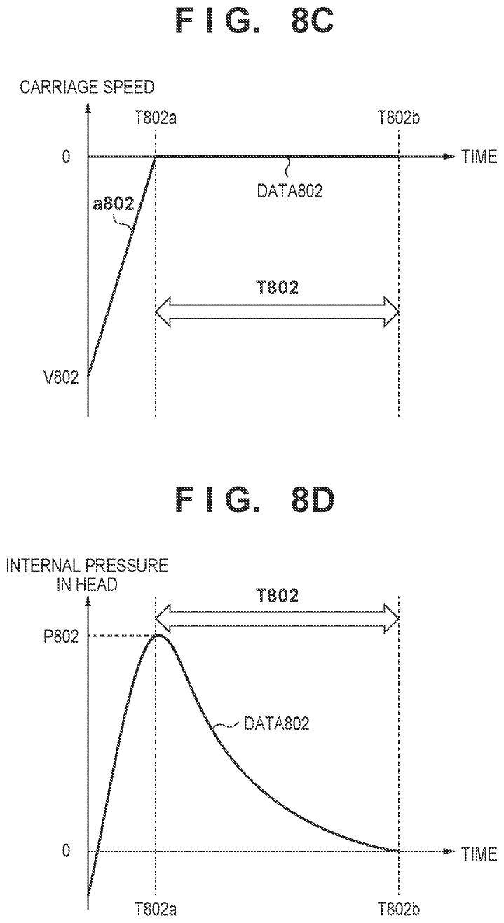

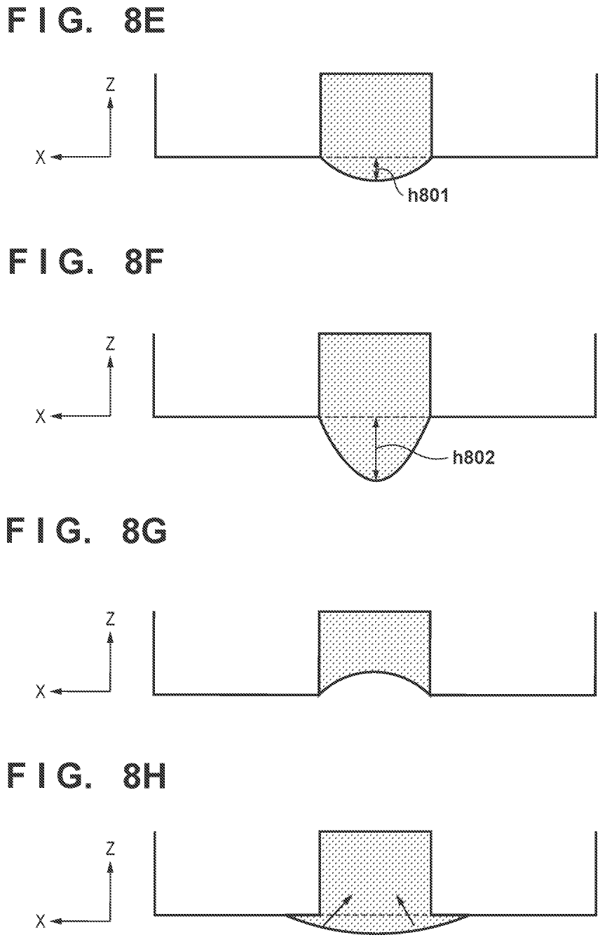

FIG. 8A illustrates a carriage speed profile when the time at which the carriage, which had been moving at speed V801, decelerates at a deceleration of a801 (inch/sec²) and stops above the recovery unit is T801a, and when the time at which the internal pressure in the print head reaches 0 is T801b. FIG. 8B illustrates the internal pressure profile of the print head at that time. Additionally, FIG. 8C illustrates a carriage speed profile when the time at which the carriage, which had been moving at speed V802, decelerates at a deceleration of a802 (inch/sec²) (a802>a801) and stops above the recovery unit is T802a, and when the time at which the internal pressure in the print head reaches 0 is T802b. FIG. 8D illustrates the internal pressure profile of the print head at that time. In FIGS. 8A and 8C, the horizontal axis represents time and the vertical axis represents the carriage speed. Additionally, the speed at which the carriage moves in the positive direction of the X axis in FIG. 1 is assumed to be positive. In FIGS. 8B and 8D, the horizontal axis represents time and the vertical axis represents the internal pressure in the print head.

As illustrated in FIGS. 8B and 8D, the internal pressure in the print head is a positive pressure (P802>P801>0) when the carriage is stopped in both cases. FIG. 8E is a cross-sectional view of the vicinity of the discharge ports when the internal pressure in the print head reaches P801, and FIG. 8F is a cross-sectional view of the vicinity of the discharge ports when the internal pressure in the print head reaches P802. Both drawings illustrate cross-sections taken along an X-Z plane in FIG. 1. As illustrated in FIGS. 8E and 8F, the meniscus of the ink formed at the discharge port is convex when the internal pressure in the print head is a positive pressure. If the wiper makes contact in this state, the meniscus of the ink may be broken. In other words, if wiping is performed immediately after the carriage stops, there is a high risk of ink leaking from the discharge port. Furthermore, because P802>P801, the meniscus height from the discharge port surface is h802>h801. As such, particularly in the case of FIG. 8C, ink may leak more than in the case of FIG. 8A. If the carriage then starts moving again, ink may leak and drip from the discharge ports onto the print medium or the like.

Accordingly, in the present embodiment, a wait time is provided in a state where the carriage is stopped, until the internal pressure in the print head drops from a positive pressure to a negative pressure, and the wiping operations are shifted to after the wait time. If a wait time of T802 (sec) or longer from time T802a to time T802b in FIG. 8D is provided, wiping can be performed in a state where the internal pressure in the print head is a negative pressure, in both FIGS. 8C and 8A. As illustrated in FIG. 8G, there is a low risk of ink leakage when wiping is performed when the internal pressure in the print head is a negative pressure. This makes it possible to suppress situations where ink leaks and drips from the discharge ports onto the print medium or the like, even if the carriage subsequently moves.

As illustrated in FIGS. 8B and 8D, the time until the internal pressure in the print head becomes a negative pressure is different in FIGS. 8A and 8C (T801<T802). As such, optimizing the wait time in the case of FIG. 8A and introducing control that makes the wait time shorter than in the case of FIG. 8C makes it possible to suppress a drop in throughput.

Furthermore, this wait time can be optimized according to the scan width and the printing strike density (also called “duty” hereinafter). “Printing strike density” refers to the ratio (%) of ink dots applied to a predetermined region during the movement of the carriage in the present embodiment, and applying one ink dot to a region of 1/1200 inch square (a 1200-dpi square) is defined as a duty of 100%.

While the carriage moves at a constant speed, the internal pressure in the print head converges on the reference pressure P0. Here, “reference pressure P0” is the pressure in the print head 101 when the carriage is at rest (−80 (mmaq)). When the internal pressure in the print head in period D illustrated in FIG. 6B is higher than the reference pressure P0, the longer the scan width is immediately before the wiping operations and the longer the period E in which the carriage moves at a constant speed is, the closer the internal pressure in the print head drops to the reference pressure P0.

On the other hand, the shorter the scan width is immediately before the wiping operations and the shorter the period E in which the carriage moves at a constant speed is, the smaller the range of the drop in the internal pressure in the print head becomes, and the internal pressure does not converge on the reference pressure P0. Accordingly, the carriage starts decelerating in period F without the internal pressure in the print head having dropped sufficiently, and the internal pressure in the print head after the carriage stops is high. Accordingly, in the present embodiment, control is performed such that the shorter the scan width is immediately before the wiping operations, the longer the wait time is before the wiping operations.

In addition, a higher duty during printing means that more ink is discharged from the print head. In other words, not only is ink returned from inside the print head to the tank side through the supply tube while the carriage is moving at a constant speed, but ink in the print head also decreases as a result of the discharge. The internal pressure in the print head is therefore more likely to decrease when the duty is high. Accordingly, in the present embodiment, when the carriage is stopped for wiping operations, control is performed such that the higher the duty is in the scan, the shorter the wait time is until the wiping operations.

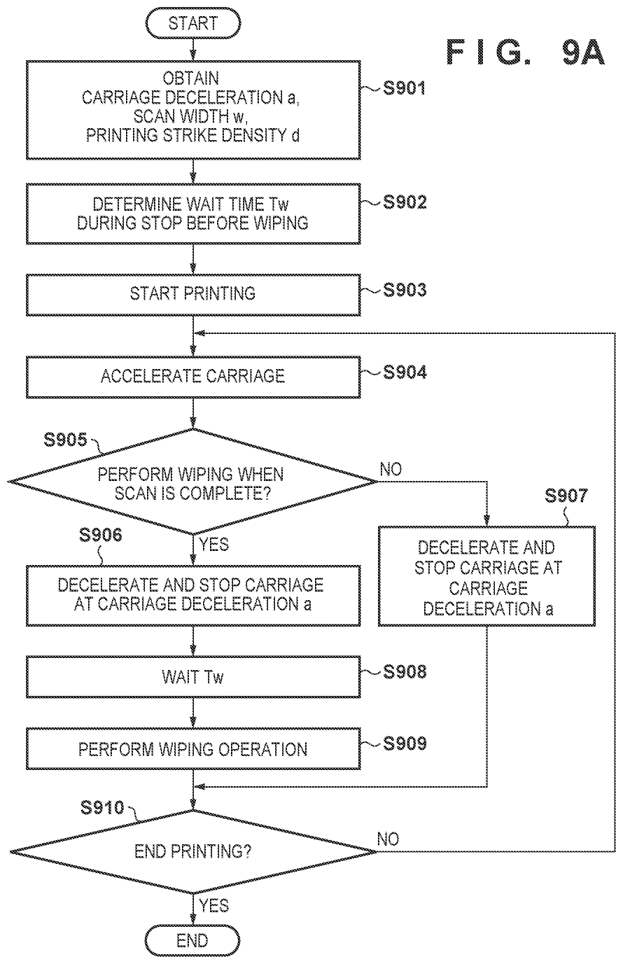

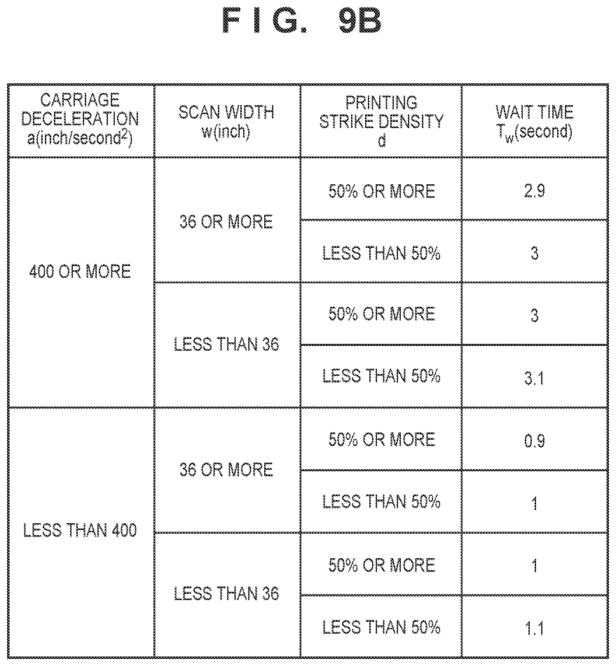

In the present embodiment, the wait time is determined by all the factors of carriage deceleration, scan width, and printing strike volume. FIG. 9A is a flowchart illustrating operations of the printing apparatus from the start to the end of printing. FIG. 9B is a table of wait times according to carriage deceleration, scan width, and duty.

In step S901, at the start of printing, a carriage deceleration a, a scan width w, and a printing strike density (duty) d in that printing mode are obtained. In step S902, a wait time Tw during the stop before wiping is determined from these values based on the table in FIG. 9B.

In the present embodiment, for example, when the carriage deceleration is 400 (inches/sec²) or more, the scan width is 36 (inches), and the duty is 50 (%), the wait time is set to 2.9 (sec).

After printing starts in step S903, the carriage is accelerated in step S904.

In step S905, it is determined whether wiping is to be performed after the scan is completed. Specifically, the number of dots discharged from the print head in the printing operations is counted as a dot count value, and when this count value exceeds a predetermined value, it is determined that wiping is to be performed. Alternatively, the time since the last time wiping was performed is counted as a timer count value, and when this count value exceeds a predetermined value, it is determined that wiping is to be performed. The dot count value or the timer count value is cleared (set to 0) after the wiping. If wiping is determined to be performed through the above determination method, the carriage is stopped in step S906, the apparatus waits for the wait time Tw to pass in step S908, and the wiping is performed in step S909.

On the other hand, if it is determined in step S905 that wiping is not to be performed after the end of scanning, the carriage is stopped at the deceleration a in step S907.

In step S910, it is determined whether to end the printing. If not, the sequence returns to step S904, and if so, the operations of this flow end.

As described thus far, according to the present embodiment, a wait time until the internal pressure in the print head drops from a positive pressure to a negative pressure is provided in a carriage stopped state according to the deceleration for stopping the carriage, the scan width, and the printing strike density, and wiping is performed after the wait time. This makes it possible to suppress situations where ink leaks and drips from the discharge ports onto the print medium or the like, even if the carriage starts moving again after the wiping.

Although a specific time has been given for the wait time, the wait time is not limited to the above value, as long as the wait time is longer than the time required for the internal pressure in the print head to drop from a positive pressure to a negative pressure.

Additionally, although the determination as to whether to perform wiping is made in step S905, the number of scans the carriage makes before wiping may be set in advance, such as every time or every several times the carriage is moved to the home position.

Additionally, if the internal pressure in the print head does not become positive immediately after the carriage stops at less than a predetermined carriage deceleration (e.g., less than 100 (inches/sec²)), the wait time may be set to 0 (sec).

In the present embodiment, as illustrated in FIG. 9B, the wait time is determined by providing two levels each for the carriage deceleration, the scan width, and the duty, but each of these may be divided into a greater number of levels.

Additionally, in the present embodiment, the wait time is determined by referring to all three factors of carriage deceleration, scan width, and duty, but it is sufficient to determine the wait time based on at least one of these factors.

Here, the “carriage deceleration” may be obtained by referring to a signal for carriage speed control, or by referring to the results of real-time measurements using an accelerometer or the like.

### Second Embodiment

A second embodiment will be described next. The second embodiment will describe a method for controlling the carriage deceleration when the carriage is stopped to perform wiping operations.

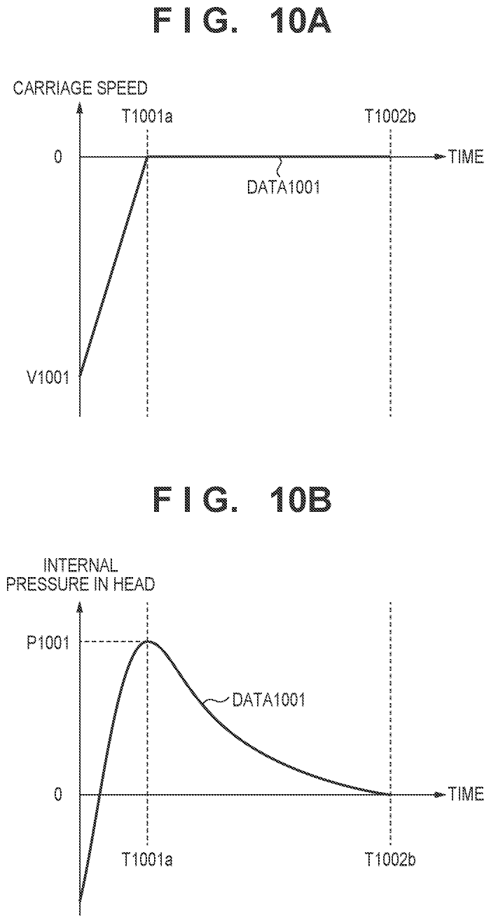

FIG. 10A illustrates the carriage speed profile from when the carriage starts decelerating to when the carriage stops above the recovery unit 107 and the internal pressure in the print head becomes 0, and FIG. 10B illustrates the internal pressure profile of the print head at that time. In FIG. 10A, the horizontal axis represents time and the vertical axis represents the carriage speed. The speed at which the carriage moves in the positive direction of the X axis in FIG. 1 is assumed to be positive. In FIG. 10B, the horizontal axis represents time and the vertical axis represents the internal pressure in the print head.

The following will describe a case where printing is performed using a printing mode having the carriage speed profile indicated by data 1001 in FIGS. 10A and 10B (a carriage deceleration of 500 (inches/sec²).

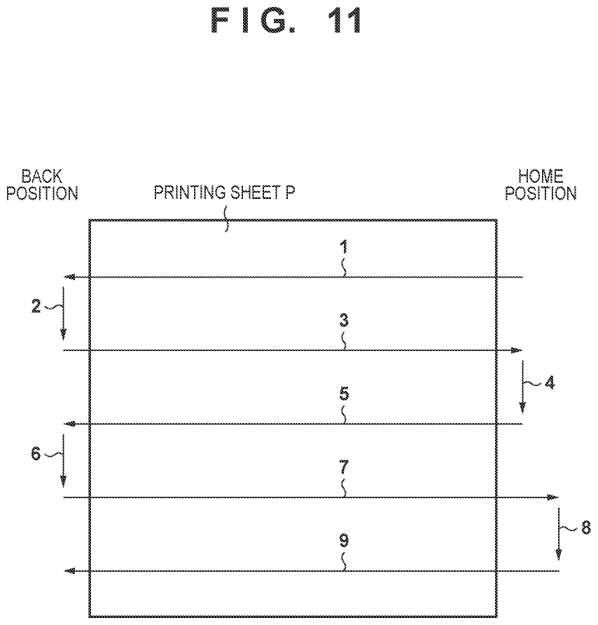

FIG. 11 is a diagram illustrating, as vectors, the carriage scanning during printing on a print medium P. Scans 1, 3, and 5 are scans that do not include wiping operations before and after the scan. The following will describe a case in which wiping operations are performed at the end of scan 7 and then scan 9 is started.

Because it is necessary for the carriage to move to the recovery unit in order to shift to the wiping operations, the carriage movement distance is longer in scans 7 and 9 than in scans 1, 3, and 5. If the deceleration in scan 7 is, for example, the same as the deceleration in FIG. 10A, the internal pressure in the print head when the carriage stops is a positive pressure (P1001>0), as indicated by the data 1001 in FIG. 10B. As such, if the wiping operations are started immediately after the carriage stops, ink may leak and drip down.

Accordingly, in the present embodiment, when the carriage deceleration is such that the internal pressure in the print head after the carriage stops becomes a positive pressure, the carriage deceleration is switched to a smaller value when performing the wiping operations than the carriage deceleration when the wiping operations are not performed. In addition, as described in the first embodiment, the shorter the scan width is or the lower the duty is, the higher the internal pressure in the print head becomes when the carriage stops. Accordingly, furthermore, in the present embodiment, control is performed such that the shorter the scan width is or the lower the duty is in the printing operations, the lower the carriage deceleration is after the switch.

Whether to switch the carriage deceleration at which the carriage is stopped when performing the wiping operations is determined according to whether a predetermined carriage deceleration is exceeded. The predetermined carriage deceleration is a carriage deceleration at which the internal pressure in the print head does not become a positive pressure when the carriage stops.

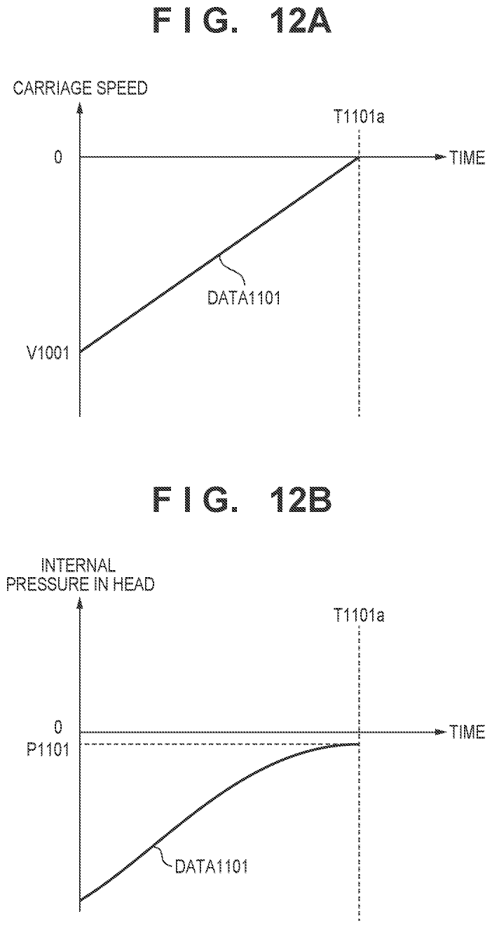

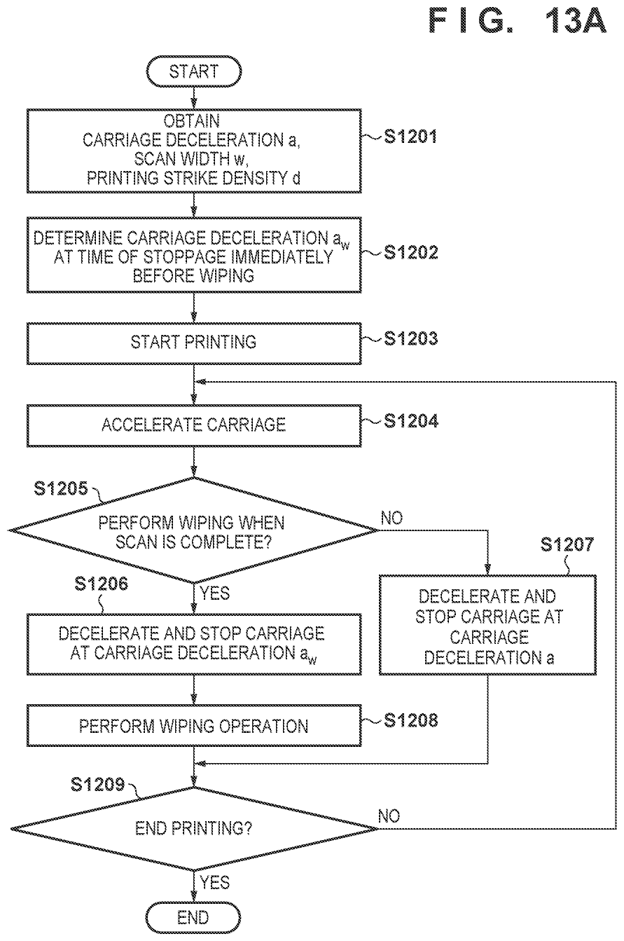

FIG. 12A illustrates the carriage speed profile from when the carriage starts decelerating at the stated predetermined deceleration to when the carriage stops above the recovery unit, and FIG. 12B illustrates the internal pressure profile of the print head at that time. In FIG. 12A, the horizontal axis represents time and the vertical axis represents the carriage speed. The speed at which the carriage moves in the positive direction of the X axis in FIG. 1 is assumed to be positive. In FIG. 12B, the horizontal axis represents time and the vertical axis represents the internal pressure in the print head. It is desirable that the deceleration in scan 7 in FIG. 11 be similar to the deceleration in FIG. 12B.

Data 1101 in FIG. 12A indicates a carriage deceleration that is lower than the carriage deceleration indicated by the data 1001 (e.g., 100 (inches/sec²)). In this case, the internal pressure in the print head after the carriage stops is not a positive pressure (P1101<0), as indicated by the data 1101 in FIG. 12B. Accordingly, the wiping operations can be performed immediately after the carriage stops.

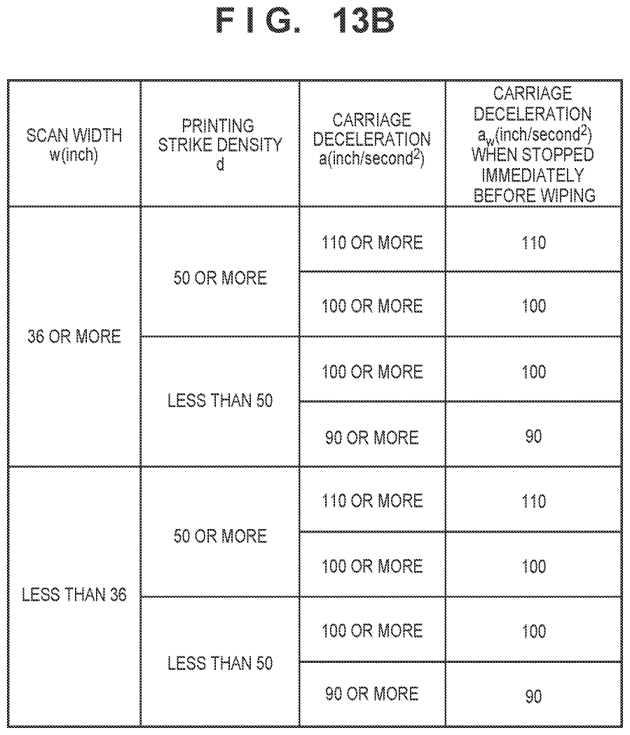

FIG. 13A is a flowchart illustrating operations of the printing apparatus from the start to the end of printing, and FIG. 13B is a table of decelerations immediately before wiping according to the carriage deceleration, the scan width, and the duty.

In FIG. 13A, in step S1201, at the start of printing, the carriage deceleration a, the scan width w, and the printing strike density (duty) d in that printing mode are obtained. In step S1202, a carriage deceleration aw immediately before wiping is determined from these values based on the table in FIG. 13B. In the present embodiment, for example, if the carriage deceleration a is 100 (inches/sec²) or more, the scan width is 36 (inches), and the duty is 50 (%), the carriage deceleration aw will be 100 (inches/sec²).

After printing starts in step S1203, the carriage is accelerated in step S1204.

In step S1205, it is determined whether wiping is to be performed after the scan is completed. Whether wiping is needed is determined by a similar method as in the first embodiment. If it is determined that wiping is to be performed, the carriage is stopped at the carriage deceleration aw in step S1206, and wiping is then performed in step S1208.

On the other hand, if it is determined in step S1205 that wiping is not to be performed after the end of scanning, the carriage is stopped at the deceleration a in step S1207.

In step S1209, it is determined whether to end the printing. If not, the sequence returns to step S1204, and if so, the operations of this flow end.

As described thus far, according to the present embodiment, if the deceleration of the carriage during normal printing is such that the internal pressure in the print head after the carriage stops is a positive pressure, the following operations are performed. That is, the carriage deceleration when wiping operations are performed is switched to a lower value than the carriage deceleration when the wiping operations are not performed. This makes it possible to suppress situations where ink leaks and drips from the discharge ports onto the print medium or the like, even if the carriage starts moving again after the wiping.

Although a specific deceleration is indicated for the carriage deceleration when the wiping operations are performed, the deceleration is not limited to the above value, as long as the carriage deceleration does not cause the internal pressure in the head to become a positive pressure after the carriage stops.

Additionally, although the descriptions of the present embodiment assume that the carriage speed is constant, the carriage speed may also be switched during a scan when the carriage is stopped for wiping operations.

Additionally, in the present embodiment, the carriage speed profile is switched for a scan in which the carriage is stopped for wiping operations. However, the carriage speed profile may be switched for a plurality of scans including a scan in which the carriage is stopped for wiping operations.

Additionally, in the present embodiment, the carriage deceleration immediately before wiping is determined by referring to all three factors of carriage deceleration, scan width, and duty, but it is sufficient to determine the carriage deceleration aw based on at least one of these factors.

In the present embodiment, the carriage deceleration immediately before wiping is determined by providing two levels each for the carriage deceleration, the scan width, and the duty, but each of these may be divided into a greater number of levels.

Although the present embodiment describes a case of shifting to wiping operations in the middle of printing, the same applies to a case of shifting to wiping operations after the end of carriage movement outside of the printing operations.

### Third Embodiment

A third embodiment will be described next. The third embodiment will describe control for setting a carriage stop time after wiping operations are performed following the carriage stopping.

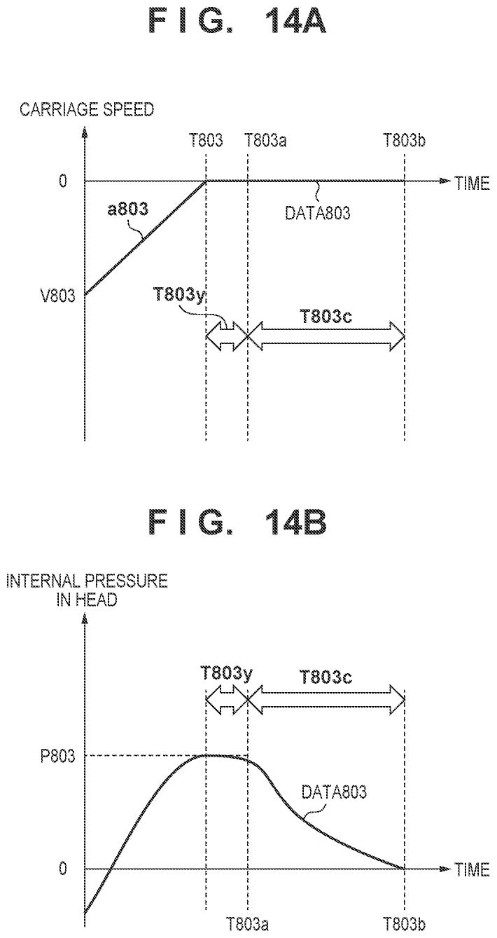

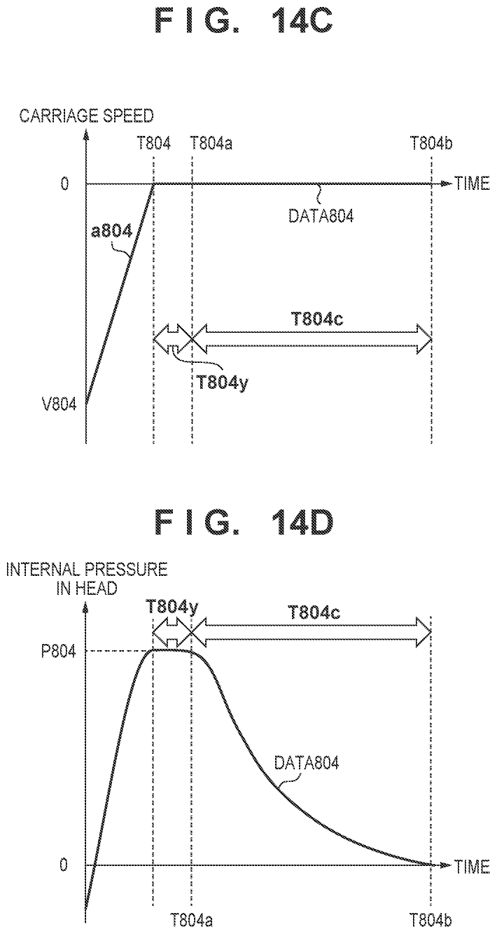

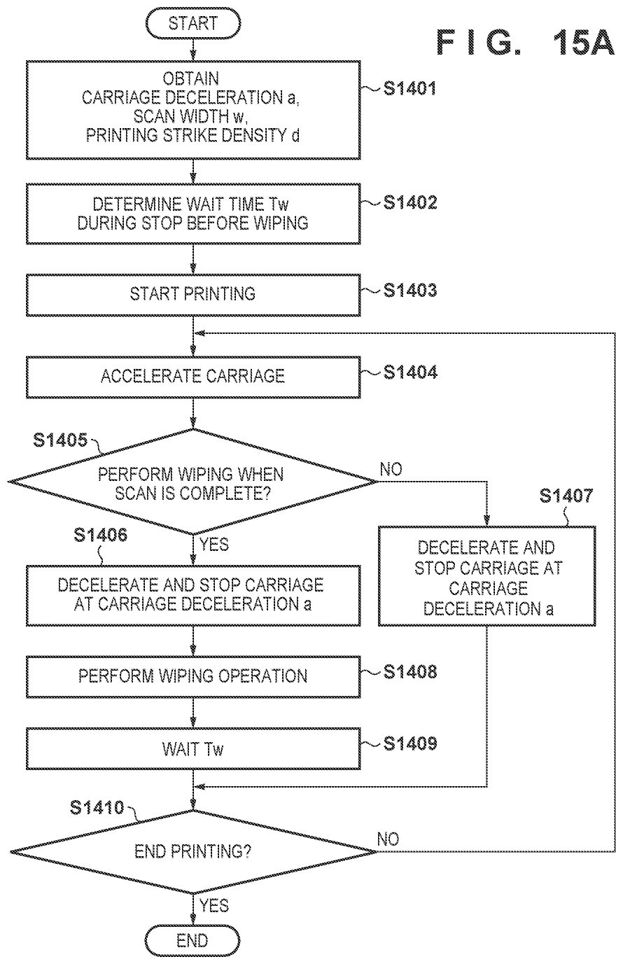

Assume that the time when the carriage, which had been moving at a speed V803, decelerates at a deceleration a803 and stops above the recovery unit is T803. Assume also that a time from when wiping is performed to when the wiping ends is T803y, and a time from a time T803a when wiping ends to a time T803b when the internal pressure in the print head reaches 0 is T803c. FIG. 14A illustrates the carriage speed profile in this case. FIG. 14B illustrates the internal pressure profile of the print head at that time.

Additionally, assume that the time when the carriage, which had been moving at a speed V804, decelerates at a deceleration a804 (a804>a803) and stops above the recovery unit is T804. Assume also that a time from when wiping is performed to when the wiping ends is T804y, and a time from a time T804a when wiping ends to a time T804b when the internal pressure in the print head reaches 0 is T804c. FIG. 14C illustrates the carriage speed profile in this case. FIG. 14D illustrates the internal pressure profile of the print head at that time. In FIGS. 14A and 14C, the horizontal axis represents time and the vertical axis represents the carriage speed. The speed at which the carriage moves in the positive direction of the X axis in FIG. 1 is assumed to be positive. In FIGS. 14B and 14D, the horizontal axis represents time and the vertical axis represents the internal pressure in the print head.

As illustrated in FIGS. 14B and 14D, the internal pressure in the print head is a positive pressure (P804>P803>0) when the carriage is stopped in both cases. FIG. 8E is a cross-sectional view of the vicinity of the discharge port when the internal pressure in the print head reaches P803, and FIG. 8F is a cross-sectional view of the vicinity of the discharge port when the internal pressure in the print head reaches P804. Both drawings illustrate cross-sections taken along an X-Z plane in FIG. 1. As illustrated in FIGS. 8E and 8F, the meniscus of the ink formed at the discharge port is convex when the internal pressure in the print head is a positive pressure. If the wiper makes contact in this state, the meniscus of the ink may be broken. In other words, if the carriage starts moving immediately after wiping is performed, there is an increased likelihood of a problem occurring in which ink leaks and drips from the discharge ports onto the print medium or the like.

Accordingly, in the present embodiment, a wait time is provided in a state where the carriage is stopped, from after the wiping is performed following the carriage stopping until the internal pressure in the print head drops from a positive pressure to a negative pressure. FIG. 8H is a cross-sectional view of the vicinity of the discharge port after wiping is performed. As illustrated in FIG. 8H, the meniscus of the ink formed at the discharge port may be broken if wiping is performed when the internal pressure in the print head is a positive pressure. However, if a wait time is provided such that the carriage does not start moving immediately, the internal pressure in the print head will attempt to converge on a negative pressure state. During this period, the ink that leaked from the discharge port due to the breakage of the ink meniscus is subjected to a capillary phenomenon (indicated by the arrow in FIG. 8H) that attempts to return the ink to the discharge port, and thus a meniscus such as that illustrated in FIG. 8G can form again. If a wait time of at least the time T804c (sec) from T804a to T804b in FIG. 14D is provided after wiping, the internal pressure in the print head can be caused to converge on a state of negative pressure in both data 803 and 804. Through this, the movement of the carriage is started when the internal pressure in the print head is a negative pressure, making it possible to suppress situations where ink leaks and drips from the discharge ports onto the print medium or the like.

Additionally, as illustrated in FIGS. 14B and 14D, the time until the internal pressure in the print head becomes a negative pressure is different in the data 803 and the data 804 (T803c<T804c). As such, optimizing the wait time in the data 803 and introducing control that makes the wait time shorter than in the data 804 makes it possible to suppress a drop in throughput.

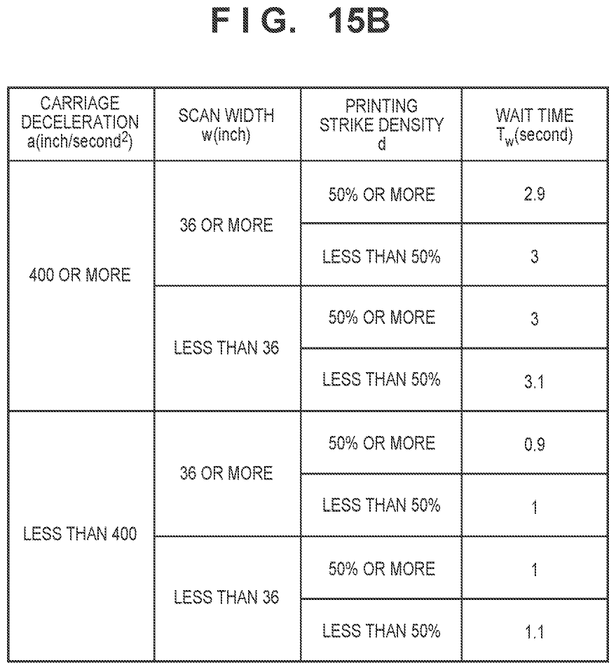

Furthermore, this wait time can be optimized according to the scan width and the printing strike density. FIG. 15A illustrates a flowchart of operations from the start to the end of printing, and FIG. 15B is a table of wait times according to the carriage deceleration, the scan width, and the duty.

In FIG. 15A, in step S1401, at the start of printing, the carriage deceleration a, the scan width w, and the printing strike density (duty) d in that printing mode are obtained. In step S1402, a wait time Tw until the carriage moves after wiping is determined from these values based on the table in FIG. 15B.

In the present embodiment, for example, when the carriage deceleration is 400 (inches/sec²) or more, the scan width is 36 (inches), and the duty is 50 (%), the wait time is set to 2.9 (sec).

After printing starts in step S1403, the carriage is accelerated in step S1404.

In step S1405, it is determined whether wiping is to be performed after the scan is completed. Specifically, the number of dots discharged from the print head in the printing operations is counted as a dot count value, and when this count value exceeds a predetermined value, it is determined that wiping is to be performed. Alternatively, the time since the last time wiping was performed is counted as a timer count value, and when this count value exceeds a predetermined value, it is determined that wiping is to be performed. The dot count value or the timer count value is cleared (set to 0) after the wiping. If wiping is determined to be performed through the above determination method, the carriage is stopped in step S1406, the wiping is performed in step S1408, and the movement of the carriage is stopped during the wait time Tw in step S1409.

On the other hand, if it is determined in step S1405 that wiping is not to be performed after the end of scanning, the carriage is stopped at the deceleration a in step S1407.

In step S1410, it is determined whether to end the printing. If not, the sequence returns to step S1404, and if so, the operations of this flow end.

As described thus far, according to the present embodiment, a wait time for putting the carriage into a stopped state until the internal pressure in the print head drops from a positive pressure to a negative pressure is provided after wiping is performed following the carriage stopping, according to the deceleration at which the carriage is stopped. This makes it possible to suppress situations where ink leaks and drips from the discharge ports onto the print medium or the like, even if the carriage starts moving again after the wiping. Although a specific time has been given for the wait time, the wait time is not limited to the above value, as long as the wait time is longer than the time required for the internal pressure in the print head to drop from a positive pressure to a negative pressure.

Additionally, although the determination as to whether to perform wiping is made in step S1405, the number of scans the carriage makes before wiping may be set in advance, such as every time or every several times the carriage is moved to the home position.

### Fourth Embodiment

A fourth embodiment will be described next. The fourth embodiment will describe control for setting a carriage stop time after wiping operations are performed at a low speed immediately before the carriage stops.

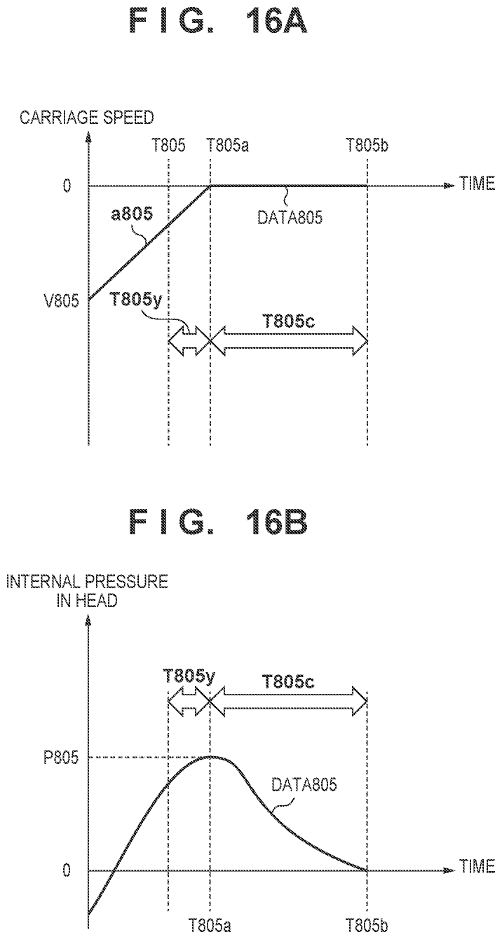

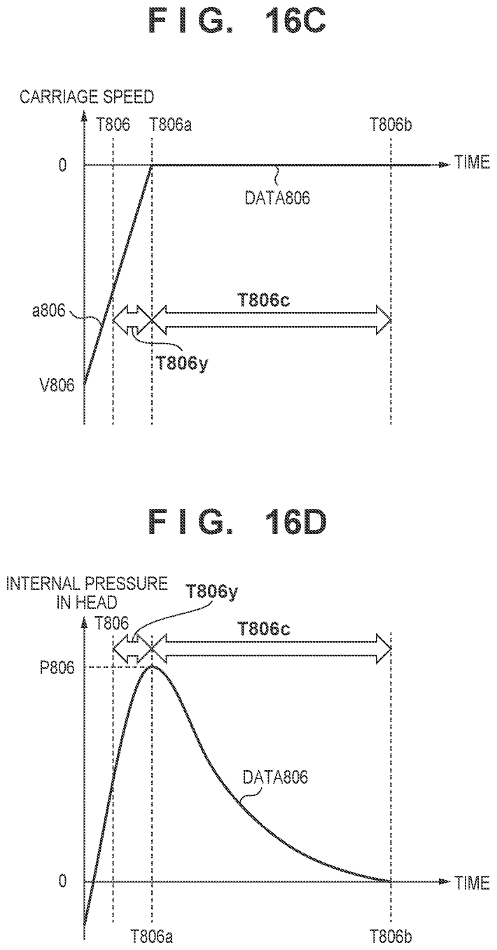

Assume that a time when wiping is started at low speed, immediately before the carriage, which had been moving at a speed V805, decelerates at a deceleration a805 and stops above the recovery unit, is T805. Assume also that a time from when wiping is performed to when the wiping ends is T805y, and the time from a time T805a when the wiping ends to a time T805b when the internal pressure in the print head reaches 0 is T805c. FIG. 16A illustrates the carriage speed profile in this case. FIG. 16B illustrates the internal pressure profile of the print head at that time.

Additionally, assume that a time when wiping is started at low speed, immediately before the carriage, which had been moving at a speed V806, decelerates at a deceleration a806 (a806>a805) and stops above the recovery unit, is T806. Assume also that a time from when wiping is performed to when the wiping ends is T806y, and the time from a time T806a when the wiping ends to a time T806b when the internal pressure in the print head reaches 0 is T806c. FIG. 16C illustrates the carriage speed profile in this case. FIG. 16D illustrates the internal pressure profile of the print head at that time. In FIGS. 16A and 16C, the horizontal axis represents time and the vertical axis represents the carriage speed. The speed at which the carriage moves in the positive direction of the X axis in FIG. 1 is assumed to be positive. In FIGS. 16B and 16D, the horizontal axis represents time and the vertical axis represents the internal pressure in the print head.

As illustrated in FIGS. 16B and 16D, the internal pressure in the print head is a positive pressure (P806>P805>0) at low speed immediately before the carriage stops in both cases. Similar to the third embodiment described above, if the wiper makes contact with the discharge port surface in this state, the meniscus of the ink may be broken. In other words, if the carriage starts moving immediately after wiping is performed, ink may leak and drip from the discharge ports onto the print medium or the like.

Accordingly, in the present embodiment, a wait time is provided in a state where the carriage is stopped, from after the wiping is performed at low speed immediately before the carriage stops until the internal pressure in the print head drops from a positive pressure to a negative pressure. As in the third embodiment, FIG. 8H is a cross-sectional view of the vicinity of the discharge port after wiping is performed. As illustrated in FIG. 8H, the meniscus of the ink formed at the discharge port may be broken if wiping is performed when the internal pressure in the print head is a positive pressure. However, if a wait time is provided such that the carriage does not start moving immediately, the internal pressure in the print head will attempt to converge on a negative pressure state. During this period, the ink that leaked from the discharge port due to the breakage of the ink meniscus is subjected to a capillary phenomenon (indicated by the arrow in FIG. 8H) that attempts to return the ink to the discharge port, and thus a meniscus such as that illustrated in FIG. 8G can form again. If a wait time of at least the time T806c (sec) from time T806a to time T806b in FIG. 16D is provided after wiping, the internal pressure in the print head can be caused to converge on a state of negative pressure in both data 805 and 806. Through this, the movement of the carriage is started when the internal pressure in the print head is a negative pressure, making it possible to suppress situations where ink leaks and drips from the discharge ports onto the print medium or the like.

Additionally, as illustrated in FIGS. 16B and 16D, the time until the internal pressure in the print head becomes a negative pressure is different in the data 805 and the data 806 (T805c<T806c). As such, optimizing the wait time in the data 805 and introducing control that makes the wait time shorter than in the data 806 makes it possible to suppress a drop in throughput.

Furthermore, this wait time can be optimized according to the scan width and the printing strike density, similar to the first and third embodiments.

As described thus far, according to the present embodiment, a wait time in a carriage stopped state until the internal pressure in the print head drops from a positive pressure to a negative pressure is provided after wiping is performed at low speed immediately before the carriage stops, according to the deceleration at which the carriage is stopped. This makes it possible to suppress situations where ink leaks and drips from the discharge ports onto the print medium or the like, even if the carriage starts moving again after the wiping. Furthermore, because wiping is performed before the carriage stops, the time required for the carriage to start decelerating and then accelerate again after the wiping is performed is shorter than in the foregoing embodiments, which improves throughput. Accordingly, this is particularly desirable when wiping is performed frequently, such as every time or every several times the carriage is moved to the home position.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-094575, filed Jun. 4, 2021, which is hereby incorporated by reference herein in its entirety.

1. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when a deceleration when stopping the carriage is a first deceleration, a time from when the carriage stops to when the wiping unit starts wiping the discharge port surface is set to a first time, and when the deceleration when stopping the carriage is a second deceleration lower than the first deceleration, the time from when the carriage stops to when the wiping unit starts wiping the discharge port surface is set to a second time shorter than the first time.

2. The printing apparatus according to claim 1,
wherein the first deceleration and the second deceleration are decelerations at which an internal pressure in the print head when the carriage stops is a positive pressure.

3. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when a movement distance at a constant speed of the carriage before stopping the carriage is a first distance, a time from when the carriage stops to when the wiping unit starts wiping the discharge port surface is set to a first time, and when the movement distance at the constant speed of the carriage is a second distance longer than the first distance, the time from when the carriage stops to when the wiping unit starts wiping the discharge port surface is set to a second time shorter than the first time.

4. The printing apparatus according to claim 3,
wherein an internal pressure of the print head is a positive pressure at a point in time when the carriage stops.

5. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the carriage stops to when the wiping unit starts wiping the discharge port surface is set to a first time, and when the printing strike density is a second strike density higher than the first strike density, the time from when the carriage stops to when the wiping unit starts wiping the discharge port surface is set to a second time shorter than the first time.

6. The printing apparatus according to claim 5,
wherein an internal pressure of the print head is a positive pressure at a point in time when the carriage stops.

7. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when the carriage is stopped without wiping the discharge port surface, a deceleration of the carriage is set to a first deceleration, and when the carriage is stopped in order to wipe the discharge port surface, the deceleration of the carriage is set to a second deceleration lower than the first deceleration.

8. The printing apparatus according to claim 7,
wherein the first deceleration is a deceleration at which an internal pressure in the print head when the carriage stops is a positive pressure.

9. The printing apparatus according to claim 7,
wherein the second deceleration is a deceleration at which an internal pressure in the print head when the carriage stops is a negative pressure.

10. The printing apparatus according to claim 7,
wherein the control unit sets the deceleration of the carriage to the second deceleration when a movement distance at a constant speed of the carriage before stopping the carriage in order to wipe the discharge port surface is a first distance, and sets the deceleration of the carriage to a third deceleration lower than the second deceleration when the movement distance at the constant speed of the carriage is a second distance shorter than the first distance.

11. The printing apparatus according to claim 7,
wherein the control unit sets the deceleration of the carriage to the second deceleration when a printing strike density indicating a ratio of ink dots applied to a predetermined region of the print medium during the movement operation of the carriage before the carriage is stopped in order to wipe the discharge port surface is a first strike density, and sets the deceleration of the carriage to a third deceleration lower than the second deceleration when the printing strike density is a second strike density lower than the first strike density.

12. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when a deceleration when stopping the carriage is a first deceleration, a time from when the wiping unit finishes wiping the discharge port surface to when a next movement operation of the carriage starts is set to a first time, and when the deceleration when stopping the carriage is a second deceleration lower than the first deceleration, the time from when the wiping unit finishes wiping the discharge port surface to when the next movement operation of the carriage starts is set to a second time shorter than the first time.

13. The printing apparatus according to claim 12,
wherein the wiping of the discharge port surface by the wiping unit is started after the carriage stops.

14. The printing apparatus according to claim 12,
wherein the wiping of the discharge port surface by the wiping unit is started before the carriage stops.

15. The printing apparatus according to claim 12,
wherein the first deceleration and the second deceleration are decelerations at which an internal pressure in the print head when the carriage stops is a positive pressure.

16. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when a movement distance at a constant speed of the carriage before stopping the carriage is a first distance, a time from when the wiping unit finishes wiping the discharge port surface to when a next movement operation of the carriage starts is set to a first time, and when the movement distance at the constant speed of the carriage is a second distance longer than the first distance, the time from when the wiping unit finishes wiping the discharge port surface to when the next movement operation of the carriage starts is set to a second time shorter than the first time.

17. The printing apparatus according to claim 16,
wherein the wiping of the discharge port surface by the wiping unit is started after the carriage stops.

18. The printing apparatus according to claim 16,
wherein the wiping of the discharge port surface by the wiping unit is started before the carriage stops.

19. The printing apparatus according to claim 16,
wherein an internal pressure of the print head is a positive pressure at a point in time when the carriage stops.

20. A printing apparatus comprising:
a carriage including a print head that discharges ink, the carriage reciprocally moving relative to a print medium;
a wiping unit configured to wipe a discharge port surface in which an ink discharge port of the print head is formed; and
a control unit configured to control a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the wiping unit finishes wiping the discharge port surface to when a next movement operation of the carriage starts next is set to a first time, and when the printing strike density is a second strike density higher than the first strike density, the time from when the wiping unit finishes wiping the discharge port surface to when the next movement operation of the carriage starts is set to a second time shorter than the first time.

21. The printing apparatus according to claim 20,
wherein the wiping of the discharge port surface by the wiping unit is started after the carriage stops.

22. The printing apparatus according to claim 20,
wherein the wiping of the discharge port surface by the wiping unit is started before the carriage stops.

23. The printing apparatus according to claim 20,
wherein an internal pressure of the print head is a positive pressure at a point in time when the carriage stops.

24. The printing apparatus according to claim 1,
wherein the internal pressure of the print head when the carriage is stopped in order for the wiping unit to wipe the discharge port surface is higher than the internal pressure of the print head in a state where the carriage is stopped.

25. The printing apparatus according to claim 1, further comprising:
an ink tank that holds ink,
wherein ink is supplied from the ink tank to the print head using a water head difference.

26. The printing apparatus according to claim 1,
wherein the wiping unit has a wiping member constituted by a porous material having a sheet shape.

27. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when a deceleration when stopping the carriage is a first deceleration, a time from when the carriage stops to when the wiping unit starts wiping the discharge port surface is set to a first time, and when the deceleration when stopping the carriage is a second deceleration lower than the first deceleration, the time from when the carriage stops to when the wiping unit starts wiping the discharge port surface is set to a second time shorter than the first time.

28. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when a movement distance at a constant speed of the carriage before stopping the carriage is a first distance, a time from when the carriage stops to when the wiping unit starts wiping the discharge port surface is set to a first time, and when the movement distance at the constant speed of the carriage is a second distance longer than the first distance, the time from when the carriage stops to when the wiping unit starts wiping the discharge port surface is set to a second time shorter than the first time.

29. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the carriage stops to when the wiping unit starts wiping the discharge port surface is set to a first time, and when the printing strike density is a second strike density higher than the first strike density, the time from when the carriage stops to when the wiping unit starts wiping the discharge port surface is set to a second time shorter than the first time.

30. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when the carriage is stopped without wiping the discharge port surface, a deceleration of the carriage is set to a first deceleration, and when the carriage is stopped in order to wipe the discharge port surface, the deceleration of the carriage is set to a second deceleration lower than the first deceleration.

31. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when a deceleration when stopping the carriage is a first deceleration, a time from when the wiping unit finishes wiping the discharge port surface to when a next movement operation of the carriage starts is set to a first time, and when the deceleration when stopping the carriage is a second deceleration lower than the first deceleration, the time from when the wiping unit finishes wiping the discharge port surface to when the next movement operation of the carriage starts is set to a second time shorter than the first time.

32. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when a movement distance at a constant speed of the carriage before stopping the carriage is a first distance, a time from when the wiping unit finishes wiping the discharge port surface to when a next movement operation of the carriage starts is set to a first time, and when the movement distance at the constant speed of the carriage is a second distance longer than the first distance, the time from when the wiping unit finishes wiping the discharge port surface to when the next movement operation of the carriage starts is set to a second time shorter than the first time.

33. A method of controlling a printing apparatus, the printing apparatus including a carriage which has a print head that discharges ink and which reciprocally moves relative to a print medium and a wiping unit configured to wipe a discharge port surface in which an ink discharge port of the print head is formed, the method comprising:
controlling a movement operation of the carriage and a wiping operation of the wiping unit such that when a printing strike density indicating a ratio of ink dots applied to a predetermined region of the print medium during the movement operation of the carriage before the carriage is stopped is a first strike density, a time from when the wiping unit finishes wiping the discharge port surface to when a next movement operation of the carriage starts next is set to a first time, and when the printing strike density is a second strike density higher than the first strike density, the time from when the wiping unit finishes wiping the discharge port surface to when the next movement operation of the carriage starts is set to a second time shorter than the first time.
